(19) United States
(12) Patent Application Publication
(10) Pub. No.: US 2026/0087039 A1
(43) Pub. Date: Mar. 26, 2026

(54) Content Generation Using Parallel AI Pipelines And Selective Output Refinement

(71) Applicants: Raghav Ramabadran, Houston, TX (US); Saurav Kumar Singh, Portland, OR (US)

(72) Inventors: Raghav Ramabadran, Houston, TX (US); Saurav Kumar Singh, Portland, OR (US)

(21) Appl. No.: 19/334,090

(22) Filed: Sep. 19, 2025

Related U.S. Application Data
(60) Provisional application No. 63/697,207, filed on Sep. 20, 2024.

(51) Int. Cl. G06F 16/3329; G06F 11/34; G06F 16/3332

(52) U.S. Cl. CPC G06F 16/3329; G06F 11/3409; G06F 16/3334

(57) ABSTRACT

Content generation inputs are received. A plurality of content options are generated based on the content generation inputs, where each content option is generated using a distinct processing sequence of one or more large language models. The plurality of content options are presented to a user. User input selecting at least one of the plurality of content options as selected content is received. The selected content is then published.

### CROSS REFERENCE TO RELATED APPLICATION(S)

This application claims priority to and the benefit of U.S. Provisional Patent Application Ser. No. 63/397,207, filed Sep. 20, 2024, the entire disclosure of which is incorporated herein by reference in its entirety.

### FIELD

This disclosure generally relates to artificial intelligent (AI) models, and, more specifically, to orchestrating multiple AI models in dynamically determined sequences for content generation.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a content orchestration system, which can be or include a distributed computing system, a cloud computing system, and/or a clustered computing system, among other examples.

FIG. 2 is a block diagram of an example internal configuration of a computing device of an electronic computing and communications system.

FIG. 3 visually illustrates an example of alternative strategies for combining outputs from a sequence of LLMs to generate optimized content.

FIG. 4A illustrates a user interface for brand development and positioning within the AI orchestration platform.

FIG. 4B illustrates an example of a user interface for custom AI model training and publication integration within the AI orchestration platform.

FIG. 5A illustrates a user interface for content guidelines.

FIG. 5B illustrates a user interface that can enable entry of additional content generation parameters.

FIG. 5C illustrates a user interface for content type specification within the AI orchestration platform.

FIG. 5D illustrates a user interface for advanced features specification within the AI orchestration platform.

FIG. 5E illustrates an example of a user interface for reviewing and selecting content options generated by the AI orchestration platform.

FIG. 6 is a flowchart of an example of a technique for generating and publishing optimized content.

FIG. 7 is a flowchart of an example of a technique for adaptively optimizing artificial intelligence models based on performance feedback.

FIG. 8 is a flowchart of an example of a technique for secure artificial intelligence processing of data.

FIG. 9 is a flowchart of an example of a technique associated for generating a document using a sequence of AI models.

FIG. 10 is a flowchart of an example of a technique associated with a method for processing data using artificial intelligence.

FIG. 11 is a flowchart of an example of a technique associated with a method for generating content using artificial intelligence.

### DETAILED DESCRIPTION

The field of artificial intelligence (AI), specifically generative AI using large language models (LLMs), encompasses systems that generate text, analyze data, or produce multimedia content based on user-provided prompts. These systems, accessible via cloud-based platforms or Application Programming Interfaces (APIs), process textual inputs to produce outputs such as articles, summaries, or analytical reports. LLMs like OpenAI's ChatGPT, Google's Gemini, and Anthropic's Claude, along with open-source alternatives, have broadened access to AI capabilities for tasks in domains like marketing, healthcare, legal, and retail. A common technique, retrieval-augmented generation (RAG), enhances output relevance by retrieving external information from predefined datasets or web sources and embedding it directly into prompts. Despite these advancements, existing systems face significant limitations in enterprise applications, particularly in data confidentiality, customization, and multi-model orchestration.

A major limitation of current AI systems is the lack of robust data confidentiality mechanisms for enterprises handling sensitive information. Most LLMs operate on shared cloud infrastructures, where proprietary data, such as research and development documents or financial records, is processed in environments that may not be sufficiently isolated from other users/proprietary data. In RAG processes, sensitive information embedded in prompts is frequently transmitted to third-party servers, raising concerns about intellectual property protection and regulatory compliance in industries like healthcare and legal services. The absence of dedicated, siloed environments for each user's or entity's data restricts AI adoption for applications requiring strict confidentiality.

Another challenge is the limited customization of outputs to align with specific organizational needs. General-purpose LLMs, trained on broad datasets, typically produce generic content that lacks alignment with an entity's (e.g., company's) unique brand voice, operational context, or domain-specific requirements. To illustrate, generating marketing content or legal briefs demands tailoring to specific styles or strategies, which can be difficult for current systems to achieve without extensive manual post-editing. Fine-tuning LLMs on proprietary datasets requires significant technical expertise and computational resources, making such fine-tuning impractical for many non-expert users or smaller organizations, resulting in outputs that fail to meet nuanced enterprise needs.

Another challenge is that the orchestration of multiple LLMs to leverage their distinct strengths remains underdeveloped. Users typically rely on a single LLM, selected based on general recommendations or perceived specialization, such as legal or medical text generation. Different LLMs excel at specific tasks. For instance, one LLM may be adept at structuring outlines, and another at creative writing. Manual attempts to combine outputs from multiple LLMs involve inefficient processes, such as copying and pasting drafts between systems or subjectively merging content, requiring expertise in prompt engineering for each model. Additionally, the optimal sequence of LLMs varies by task, context, or domain, creating a combinatorial problem that complicates achieving consistent quality.

Additionally, the challenge of identifying an optimal processing sequence for a given task remains largely unaddressed, as different orderings of the same models can produce substantially different outcomes. This lack of automated mechanisms to systematically sequence, rank, or merge outputs from multiple LLMs leads to labor-intensive workflows and inconsistent results.

Many existing RAG implementations face significant challenges in dynamically controlling and prioritizing sources at enterprise scale. While RAG retrieves external data to augment LLM outputs, conventional implementations often lack sophisticated mechanisms to distinguish between trusted and untrusted sources, potentially leading to inaccuracies or hallucinations in generated content. Enterprise applications requiring benchmarking against industry standards while maintaining data confidentiality face particular implementation challenges due to the complexity of establishing secure data isolation protocols. These scalability and standardization limitations in secure data handling constrain the practical deployment of RAG systems in sensitive domains.

An additional fundamental concern with current RAG implementations involves data exposure risks that extend beyond training data usage policies. The transmission and processing of proprietary information (which, as used herein, includes proprietary, confidential, trade secret, personally identifiable, and other restricted organizational data) outside an organization's controlled ecosystem inherently creates potential vulnerabilities for data privacy and security. The architectural requirement for external data processing means that sensitive organizational information must traverse network boundaries and be processed in third-party computing environments. This external data access introduces systemic risks for intellectual property protection, regulatory compliance, and competitive intelligence security that many enterprises cannot acceptably mitigate through contractual agreements alone.

Furthermore, current AI systems lack mechanisms to integrate real-world performance feedback into content generation or analysis. As used herein, “real-world performance feedback” refers to quantifiable data reflecting how generated content performs after publication, such as user engagement rates, search engine rankings, conversion data, or click-through rates. While some platforms provide static metrics, such as readability or search engine optimization (SEO) scores commonly used in content generation tools, these metrics are captured in isolation and not utilized to refine the content generation process of AI models. Dynamic performance metrics, such as engagement rates, conversion data, or search rankings of published content, are not adaptively incorporated to improve outputs of AI models.

This absence of a feedback loop requires users to manually analyze performance data and then attempt to translate those insights into new prompts or edits. This manual process is often inefficient, difficult to scale, and fails to systematically capture and apply demonstrated success patterns, such as stylistic or structural elements that correlate with higher engagement, or to avoid characteristics associated with undesirable performance metrics.

Implementations according to this disclosure address problems such as these by providing an artificial intelligence orchestration system that intelligently coordinate multiple (i.e., more than one) AI models to generate improved content while maintaining data security and continuously improving performance through real-world feedback mechanisms. The system orchestrates multiple AI models in a sequence to iteratively refine content, integrates custom models trained on proprietary data for personalized outputs, and is configured to support data security through a sandboxed environment with query transformation for external data retrieval.

The system addresses data security concerns by receiving a query from a client entity that requires external data for processing, where the query is received by a custom artificial intelligence model (e.g., a custom language model) that is trained on data of the client entity, then transforming the query into a generic data request that excludes information specific to the client entity before transmitting it to external AI models. The system receives external data responsive to the generic data request from the external AI models and provides the external data to the custom artificial intelligence model. The custom artificial intelligence model can then process the external data in combination with proprietary data of the client entity within a secure environment to generate a response that is provided to the client entity.

As used herein, the term “AI model” serves as a broad term encompassing the various generative and analytical systems described throughout this disclosure. This includes, but is not limited to, Large Language Models (LLMs), Small Language Models (SLMs), machine learning models for decision making, transformer-based architectures, mixture-of-experts models, neural networks for content generation, and other artificial intelligence systems capable of processing and generating text, multimedia content, or analytical outputs. An AI model may be or include multiple such AI models. The AI models described herein may operate individually or in orchestrated sequences to achieve the content generation and data processing objectives disclosed.

As used herein, the term “custom artificial intelligence model” refers to an AI system specifically trained on a particular client's data to understand their unique context, terminology, and requirements. For example, a custom model for a pharmaceutical company may be trained on their drug development documentation, regulatory filings, and clinical trial data. A custom model may be trained on different data types such as financial records, legal documents, marketing materials, or technical specifications, with varying model architectures including transformer-based models, recurrent neural networks, or hybrid architectures. The “generic data request” is a version of the input that excludes any proprietary identifiers or sensitive business content, programmatically removing or abstracting client-specific information. For instance, a query such as “Compare our unreleased product X's performance with competitor product Y” is transformed into a generic request like “Provide all public performance data for competitor product Y.”

The system improves content generation efficiency by processing content generation parameters through a sequence of AI models. Each AI model in the sequence is prompted (e.g., instructed) to refine output from a previous AI model in the sequence. The system generates multiple content options using different AI model sequences. As used herein, “sequence of AI models” refers to an ordered arrangement of AI models where the output of one model serves as input to the next model in the chain, creating a multi-model pipeline that leverages the complementary strengths of various LLMs. To illustrate, a first LLM might generate an initial draft focusing on technical accuracy, a second LLM might refine the tone and style, and a third LLM might optimize for search engine performance.

As used herein, “content” refers to any form of information or media output generated as described herein, including written content such as articles, documents, reports, code (e.g., software applications, programming scripts, database queries, automation workflows), and textual communications, video content including promotional videos, instructional materials, and multimedia presentations, audio content such as podcasts, voice narrations, and spoken communications, and visual content including images, graphics, and design elements. The content generation and orchestration techniques described herein apply to all these content formats, enabling optimized content production across multiple media types while maintaining consistent quality and performance standards through intelligent model sequencing that leverages specialized capabilities for different content modalities.

To illustrate, implementations described herein can be used to address limitations in current low-code and no-code platforms by sequencing multiple LLMs to improve error rates in code generation, as well as optimizing sequences for image generation LLMs and video generation LLMs in addition to text-based processing.

Some implementations may include parallel processing architectures with output merging based on weighted scoring, dynamic sequence determination based on content type or real-time performance metrics, or conditional branching sequences that adapt based on intermediate outputs. The term “content generation parameters” refers to user-defined inputs specifying one or more of the desired content characteristics, including primary keywords, secondary keywords, target audience specifications, industry context, brand positioning, brand voice, content type requirements, desired tone, content objectives, value propositions, performance metrics, geographic location parameters, and call-to-action specifications.

The system enhances performance optimization by measuring performance metrics of published content, training the custom based on user selection data and the measured performance metrics, and incorporating the trained custom model into subsequent content generation processes.

As used herein, “performance metrics” encompasses quantifiable measures of content effectiveness including, for example, one or more of engagement rates, conversion statistics, search rankings, social media interactions, and business-specific key performance indicators such as user engagement rates, search engine rankings, conversion data, or click-through rates. For example, performance metrics for a marketing campaign may include click-through rates, lead generation numbers, and sales conversions. As another example, if a blog post generated by the system receives a higher engagement rate compared to prior posts, that data may be used to weight similar stylistic or structural patterns more heavily in a subsequent model iteration. The tracked metrics may include academic citation counts for research content, patient outcomes for healthcare materials, or compliance scores for regulatory documents.

The technical advancement includes determining a processing sequence of multiple artificial intelligence models based on user inputs and processing initial prompts through the determined sequence where output from each model serves as input to subsequent models. As used herein, “processing sequence” refers to the computational workflow that defines the order and manner in which different AI models process data to a set of desired results, creating an automated orchestration that systematically leverages the complementary strengths of various models.

To illustrate, a processing sequence for legal document generation might involve a research model, a drafting model, a citation verification model, and a compliance checking model, or an initial draft generated by a first LLM known for structural coherence may be passed to a second LLM excelling in creative language, and then to a third for fact-checking. Some implementations may include adaptive sequences that modify based on real-time quality assessments, parallel processing branches that merge at specific points, hierarchical sequences with specialized sub-models for particular tasks, or dynamic determination by a separate algorithm that selects the most suitable LLMs and their order based on specific content generation parameters.

The determination of optimal AI model sequences is based on comprehensive training using historical performance data and metric-based outcome prediction. The system systematically evaluates many (e.g., all) different combinations of AI models across multiple variables including topic of content, audience type, target location, primary keywords, and secondary keywords. Such a comprehensive assessment occurs against key performance metrics including originality, tone consistency, SEO effectiveness, readability scores, brand alignment to company standards, and brand alignment to individual writer characteristics. During initial system training, the orchestration model 116 analyzes a large corpus of published content across various industries, with human reviewers manually scoring thousands of articles to establish ground truth data. The system extracts multiple scoring factors from each article, including structural factors (such as paragraph count and words per line), content factors (including originality and tone consistency), SEO factors, and engagement predictors. These articles are benchmarked against multiple industry-standard demand generation tools to create a multi-dimensional scoring framework. This training enables the system to predict which AI model sequences will produce high-performing content for specific content types and audiences.

The system provides continuous improvement capabilities by tracking performance metrics of published documents and unused/unselected content and refining artificial intelligence models through retraining using predicted and tracked performance data, creating an adaptive feedback loop for content optimization. As used herein, “retraining” refers to the process of updating model parameters based on new performance data to improve future outputs, representing a technical improvement by creating a self-optimizing system that adapts its future outputs based on empirical performance data.

For example, analysis of performance data can be used to improve at least the following two aspects of the system. First, the logic that determines the processing sequence of AI models may be updated. If a sequence of a first, second, and third AI model consistently produces articles that rank highly on search engines for a technical audience, the system is updated to favor that specific sequence for similar future tasks. Second, the custom AI model is retrained using the text of the highest-performing published articles and associated user selection data. This retraining allows the custom AI model to learn the successful stylistic and structural patterns, making its own refinements more effective.

Some implementations may include incremental learning approaches, federated learning across multiple clients, specialized retraining for different content categories or performance objectives, continuous online learning where the model updates in near real-time as performance data is collected, or reinforcement learning from human feedback (RLHF).

The system may employ a secure, user-specific sandbox environment to process proprietary data, ensuring it remains isolated from external systems while supporting retrieval-augmented generation capabilities. As used herein, “sandbox environment” refers to a dedicated, isolated computing instance(s) such as a private cloud container, dedicated on-premise server, Amazon Web Services Virtual Private Cloud (AWS VPC), Docker container, or Kubernetes namespace that prevents the commingling of data between different client entities and segregates a user's data and compute resources. The isolated and dedicated computing instance may incorporate a secure AI (e.g., language) model proxy layer (also referred to as a secure model proxy layer) that serves as an intermediary interface to interact with all external language models. Within this proxy layer, organizational queries can be systematically anonymized, encrypted, and modified through programmatic transformations to ensure privacy protection before any external transmission occurs. The secure proxy layer maintains complete isolation of proprietary information while enabling access to external AI capabilities, ensuring that sensitive organizational data never leaves the controlled sandbox environment in its original form.

The system can integrate conventional RAG, a supported capability wherein the system fetches relevant external data to augment generative AI outputs by injecting contextually relevant information into a model's input prompt to enhance accuracy and specificity. For instance, if a user wants to write an article on General Data Protection Regulation (GDPR) compliance, the system may fetch authoritative citations from EU legislation portals and append them to the prompt. Examples of RAG implementations that may be supported can include vector search and document chunking to select relevant snippets, different retrieval pipelines for structured data (e.g., SQL) and unstructured data (e.g., PDF, TXT, HTML), real-time web crawling, or curated database access for domain-specific data.

Furthermore, the primary orchestration workflow utilizes a distinct “Post-Generative Refinement” (PGR) workflow. In contrast to conventional RAG where unstructured data is retrieved from a data source, this primary workflow treats the fully-formed content generated by one or more external models as the informational input. This externally generated content is then subsequently integrated and refined by the custom model. Again, PGR can be defined as a process where fully-formed content generated by external LLMs is treated as informational input that is subsequently integrated and refined by the custom model trained on entity-specific data.

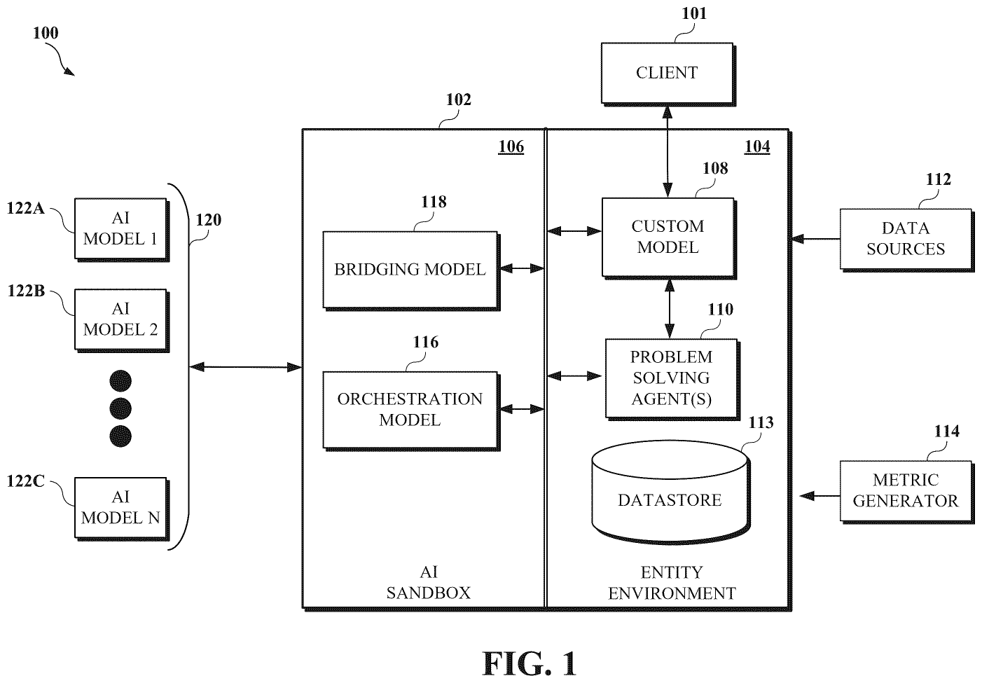

To describe some implementations in greater detail, reference is first made to examples of hardware and software structures used to implement a system for generating content using orchestrated sequences of AI models. FIG. 1 is a block diagram of an example of a content orchestration system 100, which can be or include a distributed computing system, a cloud computing system, and/or a clustered computing system, among other examples. As shown, the system 100 includes a client 101, an AI orchestration platform 102, data sources 112, a metric generator 114, and available AI models 120. The AI orchestration platform 102 is shown as including an entity environment 104 and an AI sandbox 106, communicatively coupled through various interfaces and connections.

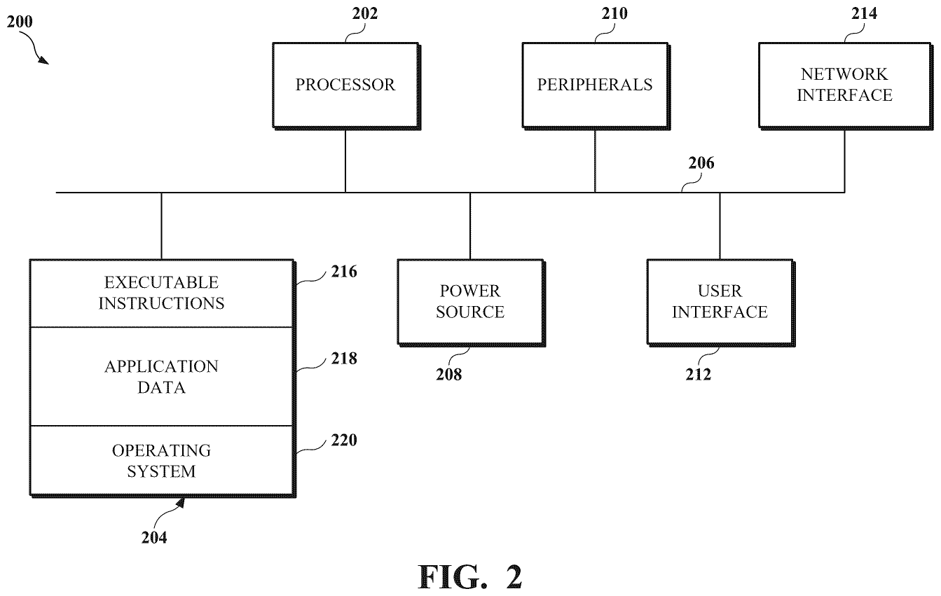

The content orchestration system 100 may be implemented using a hardware environment that includes computer system components, such as general-purpose computers, dedicated computer systems, peripheral devices, components, and modules, and/or a combination thereof. For example, the computer system components may be implemented as described with respect to FIG. 2. In some implementations, the system 100 may be implemented within one or more cloud computing environments where various components of the system 100 may be executed in various configurations, including in parallel.

The system 100 can support diverse AI model architectures including, but not limited to, RAG systems, mixture-of-experts (MoE) models, attention mechanism variants, scaling and parallelization techniques, feedforward network variants with gated activations and parameter-efficient adaptation methods, memory and recurrence architectures, retrieval- and tool-augmented models, transformer-free architectures such as state space models and convolutional sequence models, and multimodal variants including vision-language and speech-language models.

While FIG. 1 illustrates a single client 101 and a corresponding entity environment 104 for clarity, the system 100 can be designed to support a multi-tenant architecture where multiple clients each have their own dedicated and securely isolated entity environment, facilitating that data is not shared or commingled between different entities.

The system 100 can operate by combining “what is generally known” with “who the entity is” to generate highly relevant and contextually appropriate outputs. The combination of “what is generally known” can be provided through the available AI models 120, which contain broad knowledge across various domains, and the AI sandbox 106, which can orchestrate access to this external knowledge through an orchestration model 116 and a bridging model 118. The “who the entity is” aspect can be represented by the entity environment 104, which can contain a custom model 108 trained on entity-specific data, problem solving agents 110 configured for domain or problem-specific workflows, and a datastore 113 containing historical performance data and organizational context.

This dual-knowledge architecture enables the system 100 to leverage general knowledge available through external AI models while maintaining the unique identity, preferences, and strategic objectives of each client entity, resulting in content and analysis that is both broadly informed and specifically tailored to organizational needs while preventing proprietary data leaks into uncontrolled environments (e.g., the Internet and/or where the available AI models 120 may be deployed).

The client 101 may be or otherwise refer to one or both of a client device or a client application operated by a user or an entity. A client device can comprise a computing system, which can include one or more computing devices, such as a mobile phone, a tablet computer, a laptop computer, a notebook computer, or a desktop computer. A client application can be an instance of software, such as a web-based portal or a dedicated application, running on a user device. The client 101 can be an automated system or another software platform interacting with the system 100 via APIs. For example, the client 101 can be an enterprise resource planning system or a customer relationship management platform that can utilize automated content generation capabilities.

The AI orchestration platform 102 can represent a computer-implemented system that coordinates the various models and data flows to generate and optimize content while maintaining security and data isolation protocols. The AI orchestration platform 102 can be logically divided into an entity environment 104 and an AI sandbox 106, creating a secure architecture that enables external AI capabilities while protecting proprietary information. While the entity environment 104 is dedicated to and is usable by only one entity, the AI sandbox 106 may be usable or shared by several entities.

The AI orchestration platform 102 may include cloud-based computing resources such as virtual private clouds with dedicated networking, storage, and compute resources allocated specifically to individual client organizations. The AI orchestration platform 102 may include on-premises server deployments, hybrid cloud configurations, or containerized environments with security measures such as encryption at rest and in transit.

The AI sandbox 106 constitutes a computing environment within the AI orchestration platform 102 that is configured to be isolated, to interface with external AI models, and to orchestrate the content generation process, wherein the environment is further configured to reduce a risk of data leakage and to facilitate segregation of client data from external systems.

The entity environment 104 can encompass an entity-specific environment, meaning it is a dedicated and securely isolated computing instance provisioned for a single client entity that contains or incorporates proprietary data, custom models, and specialized processing capabilities. For example, the entity environment 104 could be a dedicated virtual private cloud (VPC) on AWS, a set of isolated containers, or a physically separate server that facilitates all data and processing specific to one client entity remain confidential and are not accessible by any other entity. To illustrate and without limitation, the entity environment 104 of a pharmaceutical company might contain (e.g., incorporate) clinical trial data, FDA submissions, research publications, and competitive analysis reports spanning multiple years, while the entity environment 104 of a legal firm might include case files, court transcripts, legal strategies, and regulatory compliance documents.

The custom model 108 can represent an artificial intelligence model. The custom model 108 may be an LLM, a small language model (SLM), which typically includes an orders of magnitude smaller number of parameters than an LLM, or some other AI model. To illustrate, while an LLM may include at least hundreds of billions of parameters, an SLM may include between one and three billion parameters. The custom model 108 may include transformer-based architectures such as Generative Pre-trained Transformer (GPT) variants, Bidirectional Encoder Representations from Transformers (BERT)-based models for specific tasks, other model architectures such as recurrent neural networks (RNNs), or mixture-of-experts (MoE) architectures and multimodal models that combine multiple specialized components such as vision, language, and audio processing capabilities depending on the specific use case and domain requirements.

The custom model 108 can be implemented using various underlying architectures including attention mechanism variants, scaling and parallelization techniques such as mixture-of-experts configurations, feedforward network variants with gated activation functions and parameter-efficient adaptation methods, memory and recurrence architectures, retrieval-augmented generation capabilities, transformer-free architectures such as state space models, and multimodal processing architectures. This architectural flexibility enables the custom model 108 to be optimized for specific organizational requirements and domain-specific tasks while maintaining compatibility with diverse AI model types and processing paradigms.

The custom model 108 may incorporate function-specific AI models trained for particular organizational roles such as human resources processing, research and development analysis, financial operations, marketing content generation, or customer service interactions. Additionally, the system may maintain industry-specific models optimized for sectors including healthcare, legal services, pharmaceutical research, financial services, or regulatory compliance domains. The AI orchestration platform 102 may intelligently determine which combination of function-specific and industry-specific models to merge based on the particular use case, content generation requirements, and organizational context. To illustrate, a request for clinical trial analysis documentation may trigger the integration of a healthcare-specific model with a regulatory compliance model and a technical writing model to create an optimized processing configuration. Such intelligent model selection and merging process enables the creation of task-specific composite models that leverage specialized domain knowledge while maintaining the entity's unique operational context and performance requirements.

The custom model 108 can be trained on entity-specific and proprietary data to enable personalized and contextually relevant processing capabilities. This training enables the custom model 108 to learn the unique context, style, voice, and strategic objectives of the client entity, enabling it to generate content that aligns with organizational standards and performance criteria. To illustrate, for a marketing agency, the custom model 108 may be trained on their past high-performing articles, brand guidelines, and successful campaign strategies to understand what resonates with their target audiences. On the other hand, for a law firm, the custom model 108 may be trained on successful legal motions, briefs, case strategies, and court outcomes to identify patterns that lead to favorable results.

The problem solving agents 110 can be or include specialized software routines or AI models configured or trained to perform specific workflows or tasks using the custom model 108 and data within the entity environment 104 to address domain-specific challenges or use cases.

To illustrate, a problem-solving agent 110 could be configured to execute a financial optimization or revenue cycle management workflow in domains such as healthcare, using the custom model 108 to analyze transactional data exchanged between service providers and payers. In a healthcare context, this may include analyzing claims data such as electronic data interchange (EDI) records processed through a clearinghouse, and identifying opportunities for Current Procedural Terminology (CPT) code optimization to maximize reimbursement. As another illustration, a problem solving agent 110 for a legal firm could be designed to analyze an incoming case against the strategies learned by the custom model 108 to suggest a legal approach based on historical case outcomes and judicial preferences. The problem solving agents 110 may include agents for financial analysis and fraud detection, R&D data synthesis, competitive landscape assessment, or specialized agents for different industries such as healthcare compliance, pharmaceutical research, or regulatory document generation.

In some implementations, the custom model 108 may be implemented as a MoE architecture. This architecture may leverage model merging techniques to combine multiple individual open-source AI models, each trained or fine-tuned for distinct competencies, into a unified inference system. For example, the custom model 108 may combine models such as LLAMA and Kimi K2 to take advantage of their respective strengths, such as performance in legal versus healthcare domains. This approach enables the orchestration of multiple smaller, specialized models rather than relying on a single, monolithic model with generalized knowledge, which can reduce computational costs and improve output specificity.

In some implementations, the MoE implementation may be deployed within the sandboxed entity environment 104, facilitating customer-specific privacy and control. The system may maintain a registry or database of pre-combined “expert” models, each comprising different combinations of foundational open-source models, allowing an entity's model to act as a modular, plug-and-play component. Entities may selectively connect or disconnect expert sub-models to their orchestration flow over time, enabling evolving workflows without retraining from scratch.

The datastore 113 serves as a computer-readable storage medium configured to store data relevant to the entity, including performance and training data for the operation of the system 100, encompassing performance metrics, user selection preferences, training data, and historical analytics. The datastore 113 may include, among other things, metrics on published content performance such as engagement rates and conversion statistics, user selections of preferred content options across different content types and audiences, and the weights and parameters of the custom model 108 from various training iterations. For instance, if a user consistently selects content options with a particular tone or structure that performs well in real-world deployment, this preference and performance correlation can be logged in the datastore 113 for future model training, as further described herein.

The data sources 112 represent external and internal information repositories that provide the entity-specific and proprietary data used for training the custom model 108 and the problem solving agents 110. The data sources 112 may encompass a wide variety of structured and unstructured data formats that inform the model's understanding of organizational context and performance patterns. These data sources 112 can include internal documents such as research and development (R&D) reports, financial spreadsheets, accounting databases, marketing plans, legal case files, court transcripts, internal communications, historical performance data, and other domain-specific materials.

The data sources 112 may include, by way of example and not limitation, R&D data, such as research documents, experimental results, and technical specifications stored as PDFs or Word documents; finance data, including revenue reports, budget allocations, and investment analyses stored in spreadsheets or comma-separated values (CSV) files; accounting data, comprising transaction records, audit reports, and compliance documentation maintained in database formats or structured text files; and marketing data, such as campaign performance metrics, customer analytics, and brand guidelines stored as presentations, spreadsheets, or multimedia files.

The data sources 112 can also include external but curated information, such as a list of trusted websites (e.g., WebMD for healthcare content) or untrusted sources to be avoided (e.g., tabloid magazines or unreliable news sources), enabling the system 100 (e.g., the custom model 108 and the problem solving agents 110) to maintain content quality and factual accuracy when generating content.

One or more of the data sources 112 may be implemented as or include a personal (e.g., user specific and/or user controlled) knowledge vault that serves as a comprehensive repository for user-controlled data across multiple domains and personal contexts. This personal knowledge vault may be configured to store encrypted personal documents, communications, preferences, behavioral patterns, and domain-specific expertise in formats including but not limited to personal notes, email archives, calendar data, health records, financial information, creative works, research materials, and/or learning materials. The personal knowledge vault may be deployed locally on user devices, in private cloud instances, or hybrid configurations that maintain user control over data access and encryption keys. The personal knowledge vault enables the custom model 108 to develop deep personalization capabilities by learning from the digital context of the user while maintaining privacy boundaries.

In some implementations, when processing queries, the AI orchestration platform 102 may first query the personal knowledge vault to leverage existing user knowledge and preferences before determining whether external data augmentation is necessary through the bridging model 118. This architecture enables the AI orchestration platform 102 to provide personalized responses that reflect the unique knowledge base of the user, communication style, and domain expertise while ensuring that sensitive personal information never leaves the secure environment during external LLM processing. The AI orchestration platform 102 may prioritize information from the personal knowledge vault over external sources when conflicts arise, maintaining user-specific context and preferences as the primary authority for personalized content generation.

The data sources 112 may be configured to include real-time streaming data from IoT devices, image libraries for multi-modal processing, audio/video files that can be transcribed and used for training, or APIs from third-party service providers that provide domain-specific information.

The metric generator 114 can function as a comprehensive analytics engine communicatively coupled to the entity environment 104 (e.g., to the datastore 113). The metric generator 114 may be responsible for collecting and processing performance metrics of published content to provide feedback for model improvement and optimization. These metrics can include real-world performance indicators such as user engagement rates on social media platforms, search engine rankings, website conversion rates, click-through rates from email campaigns, and business-specific key performance indicators that measure content effectiveness. For example, the metric generator 114 may be or integrate with web analytics platforms to track how many users scheduled a doctor's appointment after reading a generated healthcare article, or monitor social media engagement metrics to assess the viral potential of marketing content.

The metric generator 114 might track article performance including page views, time on page, social shares, lead generation numbers, and sales conversions across multiple platforms and timeframes. These collected metrics can then be stored in the datastore 113 to be used for retraining the custom model 108 and/or the problem solving agents 110, thereby creating a continuous feedback loop for performance improvement.

The orchestration model 116 can serve as a computer-implemented module within the AI sandbox 106 that determines a sequence of at least a subset of the available AI models 120 to use for a given content generation task. A sequence may represent a permutation of all available LLMs or a permutation of a subset of the available LLMs. The orchestration model 116 utilizes machine learning algorithms trained on historical performance data to predict which combinations and sequences, such as different permutations, of LLMs will produce results aligned with desired parameters for given input parameters.

Based on user inputs such as topic, target audience, desired tone, and content type, the orchestration model 116 can select and order a plurality of LLMs to iteratively refine the content through sequential processing. For example, the orchestration model 116 may determine that for a technical blog post targeting healthcare professionals, the sequence should start with an LLM known for factual accuracy and medical knowledge, followed by one that excels at simplifying complex topics for broader audiences, and conclude with a model that performs better with respect to SEO and engagement.

This determined sequence can then be provided to the custom model 108 to execute, enabling the system to leverage the unique strengths of different models to produce higher quality output than any single model could achieve alone. The orchestration model 116 may include reinforcement learning to continuously optimize AI model sequence selection based on performance feedback, genetic algorithms for exploring sequence combinations, dynamic orchestration that adjusts the sequence in real-time based on intermediate output quality, or rule-based expert systems incorporating domain-specific knowledge about multi-criteria optimization for model combinations. These optimization criteria can include competing factors such as processing speed, content quality, computational cost, and resource availability.

The orchestration model 116 may implement continuous re-evaluation mechanisms that assess AI model sequence performance against the optimization criteria and may automatically adjust selection algorithms based on changing performance patterns, computational resource availability, and quality requirements. This re-evaluation process enables the system 100 to adapt to evolving model capabilities, updated performance benchmarks, and shifting organizational priorities for content generation objectives.

The bridging model 118 can operate as a secure query transformation system within the AI sandbox 106 that is responsible for managing the interaction between the secure entity environment 104 and the external, non-proprietary world of available AI models 120 while maintaining data confidentiality. The problem solving agents 110 or other components within the entity environment 104 may provide specific queries to the bridging model 118 when they require external information to complete their specialized workflows. For example, the bridging model 118 can transform a specific, proprietary query from the custom model 108 or the problem solving agents 110, such as “Compare our confidential pharmaceutical compound, CardioLorem, against competing drugs in the Alzheimer's market,” into a generic, non-proprietary request, such as “What are all current drugs in the Alzheimer's market and their mechanisms of action?”

This transformation process is designed to reduce the risk of proprietary information leaving the secure environment while still obtaining relevant external data. In some implementations, the bridging model 118 might employ natural language processing techniques to identify and abstract proprietary elements such as company names, product codes, financial figures, and strategic information before formulating external queries. The bridging model 118 may scan all outgoing requests to check that no proprietary data is accidentally included, or template-based transformation systems that map proprietary queries to predefined generic formats.

The available AI models 120 can be or include a diverse collection of content generation models, including LLMs, SLMs, image generation models, video generation models, audio generation models, code generation models, and multimodal models accessible to the system 100, including both commercial and open-source options that provide specialized capabilities for different content generation and processing tasks. The system 100 can have access to the available AI models 120, which may include two or more AI models, such as AI models 122A, 122B, and 122C. These can be general-purpose, external AI models from various providers or open-source models that serve as sources of broad knowledge and generalized processing capabilities.

The orchestration model 116 can direct the flow of content through a sequence of the selected models, where the output a first AI model is used as the input for a second AI model, which refines the input further. The output of the second AI model may then be input to a third AI model in the sequence. For example, the available AI models 120 might include a first LLM for general content creation and structural coherence, a second LLM for analytical tasks and fact-checking, Codex for programming assistance, and a third LLM optimized for specific domains such as scientific writing or multilingual processing.

Alternative implementations of available AI models 120 may include fine-tuned versions of base models for specific industries, ensemble models that combine multiple architectures, continuously updated models that incorporate the latest training data and techniques, or dynamic addition and removal of LLMs from the available pool based on performance evaluations and evolving capabilities.

In operation, the system 100 can facilitate a workflow that combines external AI capabilities with proprietary data processing while maintaining strict security protocols. As already mentioned, when the custom model 108 receives a query or content request from the client 101, the custom model 108 may determine that it requires external information to provide a comprehensive response. The custom model 108 can send a request to the bridging model 118, which can transform it into a generic query that excludes any proprietary or sensitive information. The orchestration model 116 can then take this generic query and process it through a determined sequence of the available AI models 120, where each model in the sequence refines and enhances the output from the previous model.

The final, refined output from the external AI models can be passed back to the entity environment 104 (e.g., to the custom model 108) to apply PGR. For example, the custom model 108 can then perform PGR, where the custom model 108 takes the externally generated content (the “retrieved” information) and integrates it with its own internal knowledge and the proprietary context of the entity, combining broad, up-to-date external knowledge with deep, specific internal context. PGR enables models within the entity environment 104 (e.g., the custom model 108) to generate a final response or document that leverages both external AI capabilities and proprietary organizational knowledge, all within the secure entity environment 104.

The performance of this final output (e.g., published and made publicly available) can then be tracked by the metric generator 114, and the performance data stored in the datastore 113 can be used to retrain and improve the custom model 108 over time, creating a continuous feedback loop that enhances system performance and alignment with organizational objectives.

The operational workflows of the system 100 can be understood as a sophisticated, multi-stage process that determines optimal AI model (e.g., LLM) sequences and continuously refines its content generation capabilities through performance-based feedback.

The process can be founded on extensive initial training using a large corpus of publicly available articles that are manually scored by human reviewers and benchmarked against industry-standard demand generation tools. This foundational training establishes a predictive scoring model that learns the relationship between content characteristics—such as originality, tone, readability, and SEO score—and real-world performance. This model can use a vectorized mapping, analogous to a Principal Component Analysis (PCA) plot, to position new content within a spectrum of performance scores, enabling the system to predict how well an article will perform based on its similarity to known high-performing and low-performing examples. In some implementations, a predictive scoring model may be trained as part of a complementary training phase.

When a user initiates a content generation request, the system 100 leverages this predictive scoring model to identify and select multiple top-performing sequences of AI models (which may be or include one or more LLMs) from the available AI models 120 for that specific task. It then generates multiple content options for each section of the document, with each option produced by a different, computationally determined AI model sequence. The user reviews these options and makes a selection, which is logged as an “interim choice” in the datastore 113 rather than being immediately classified as good or bad. This user selection data, along with the predicted performance scores of all generated options, is stored to provide a rich dataset for future model refinement.

This continuous, adaptive feedback loop refines the system based on empirical evidence. Once the final content is published, the metric generator 114 tracks real-world performance metrics, such as engagement rates and conversion statistics. The custom model 108 is then retrained using both the user's choices and the measured performance data from the articles that performed well, effectively learning what stylistic and structural patterns resonate with the audience. Concurrently, the orchestration model 116, which is responsible for determining the optimal AI model sequences, is updated based on which sequences actually produced the highest-performing content. This self-correcting mechanism ensures that the system's ability to predict and generate high-quality content continuously improves over time.

FIG. 2 is a block diagram of an example internal configuration of a computing device 200 of an electronic computing and communications system. In one configuration, the computing device 200 may implement one or more of the client 101, the AI orchestration platform 102, components within the AI sandbox 106, components within the entity environment 104, the custom model 108, the problem solving agents 110, the datastore 113, the data sources 112, the metric generator 114, the orchestration model 116, the bridging model 118, or the available AI models 120 of the content orchestration system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network. The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

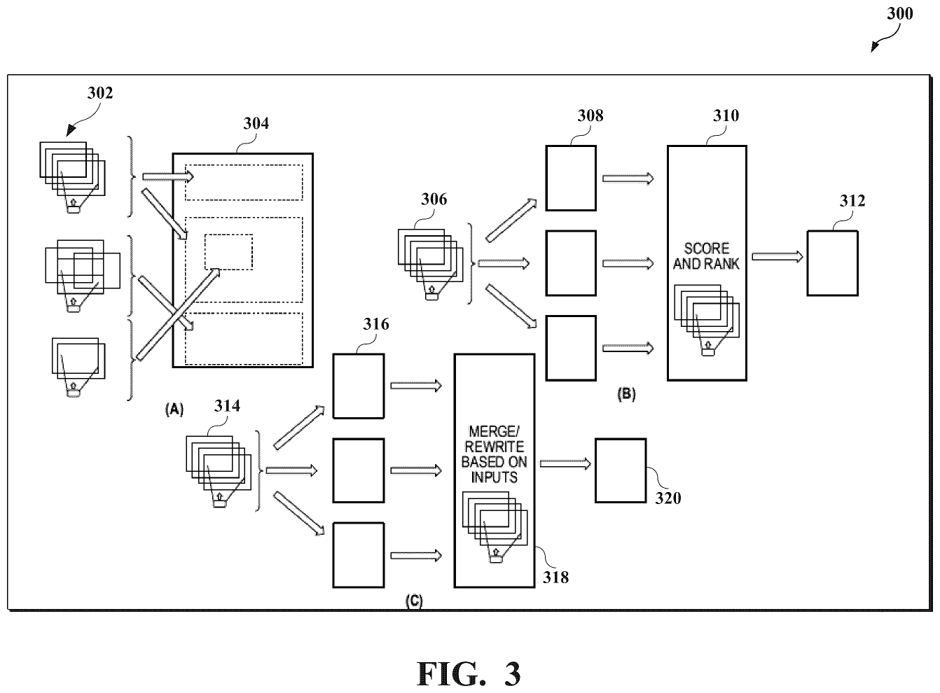

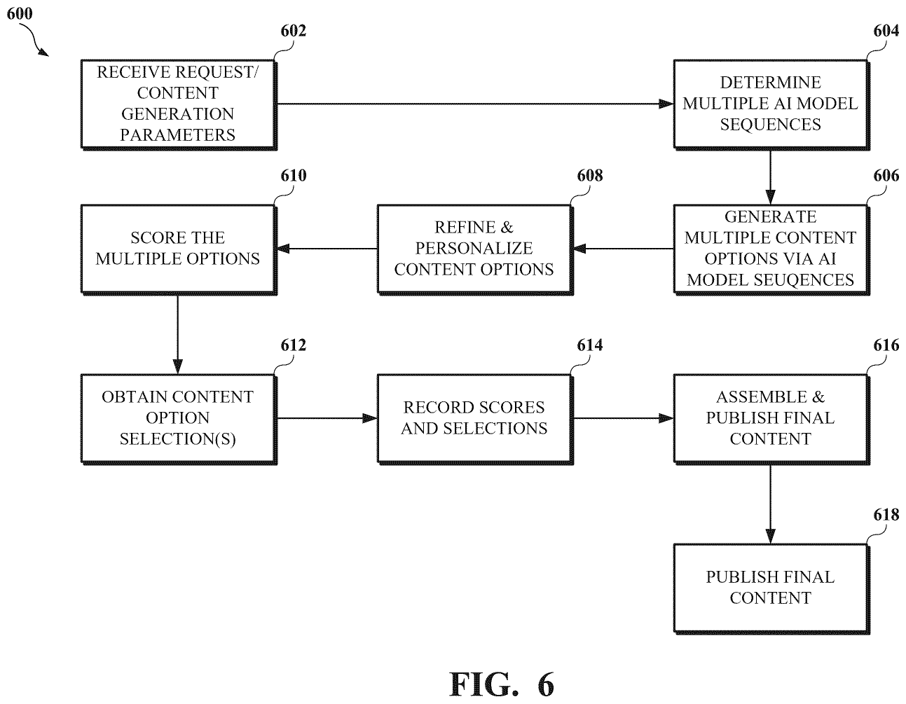

FIG. 3 visually illustrates an example 300 of alternative strategies for combining outputs from a sequence of LLMs to generate optimized content. The example 300 provides a detailed view of how the system 100 may assemble or select from the multiple content options generated in step 606 of FIG. 6, showing three distinct modes of operation labeled (A), (B), and (C), each representing a different technical approach to finalizing content from multiple LLM outputs.

Path (A) illustrates a composition or assembly strategy using section-specific generation. A plurality of initial content outputs 302, which can be distinct drafts generated by different LLM sequences, can be used to construct an assembled final document 304. In this mode, different outputs may be used for different, specific sections of the final document. For example, an introduction section may be selected from a first content output, the body paragraphs from a second content output, and the conclusion from a third content output. The final document 304 can then be programmatically assembled by combining these selected sections.

Path (B) illustrates a selection or ranking strategy based on performance scoring. A plurality of initial content outputs 306, each generated by a sequence of LLMs. Each output 308 (which may include several sections) generated by a corresponding sequence of LLMs, can be fed into a scoring and ranking process 310. The scoring and ranking can evaluate each complete content output against a set of predefined criteria, such as originality, readability, factual accuracy, or predicted SEO performance, similar to the scoring process described in step 610 of FIG. 6. A score can be assigned to each output 308. FIG. 3 illustrates that only one output 312 may be presented to a user since the one output 312 is the only one that achieved a score that a greater than a minimal score threshold.

Path (C) illustrates a synthesis or merging strategy that combines multiple outputs into unified content. A plurality of initial content outputs 314 can be provided as inputs to a merging and rewriting module 318, along with contextual constraints or user data 316. This module, which may be implemented using the custom model 108 or another AI component, can analyze the provided outputs simultaneously and generate a new, synthesized final document 320. The module can analyze the initial content outputs to generate a unified document that synthesizes elements from the multiple inputs. This approach can differ from assembly (A) and selection (B) as it can create new text based on the provided drafts, rather than combining or choosing from existing content sections.

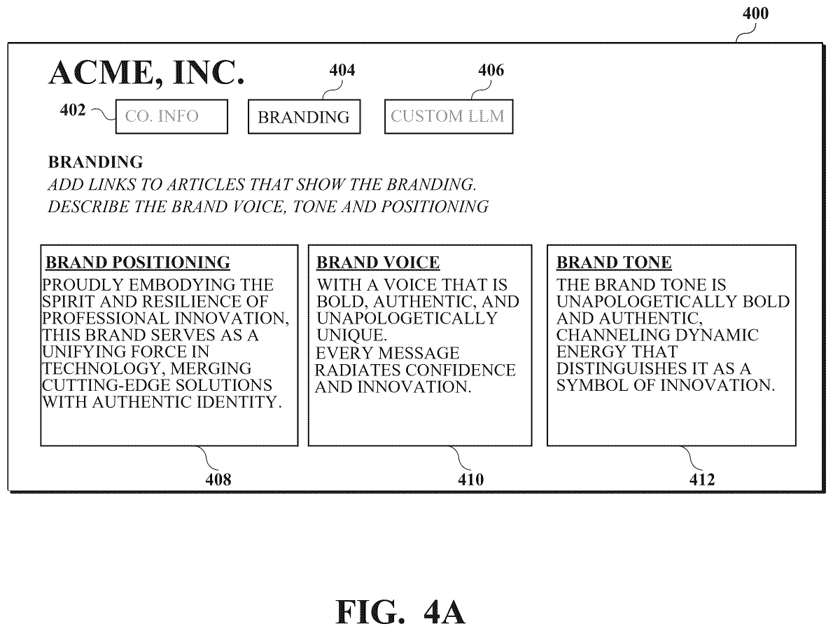

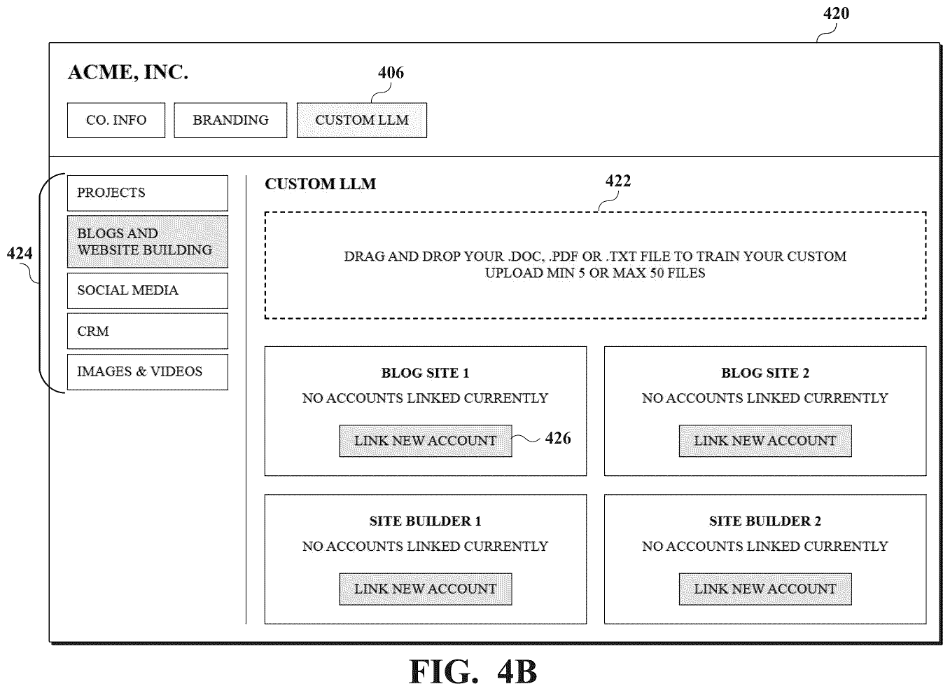

FIGS. 4A-4B illustrate examples of user interfaces that may be used in conjunction with, or generated by, the system 100 of FIG. 1. These user interfaces can demonstrate the practical implementation of the AI orchestration platform 102 for content generation and brand development. The illustrated scenarios can show how users provide information to the AI orchestration platform 102 so that content generated by the system 100 is consistent with or conforms to the provided inputs. For example, articles, technical papers, news articles, and other generated content can be aligned with the entity's established brand voice, strategic positioning, and organizational objectives as defined through these user interface interactions. The user interfaces enable users to input entity-specific information and receive AI-generated branding content that reflects both general market knowledge and organizational context.

FIG. 4A illustrates a user interface 400 for brand development and positioning within the AI orchestration platform 102. The interface 400 includes a tabbed navigation structure with three primary tabs: a company information tab 402 labeled “CO. INFO,” a branding tab 404 labeled “BRANDING,” and a custom language model tab 406 labeled “CUSTOM LLM.” After a user has entered information regarding the client entity (ACME, INC. in this example) through the company information tab 402 (which is not shown), the user interface 400 can display the branding tab 404, which shows that the branding fields have been automatically populated based on processing through the available AI models 120 shown in FIG. 1.

The branding tab 404 can include instructional text directing users to “ADD LINKS TO ARTICLES THAT SHOW THE BRANDING” and “DESCRIBE THE BRAND VOICE, TONE AND POSITIONING,” indicating how users can provide additional context for the custom model 108 training process. The interface can display three primary content fields: a brand positioning field 408, a brand voice field 410, and a brand tone field 412. For example, the orchestration model 116 can generate one or more prompts from the entity information and provide the one or more prompts to a determined sequence of the available AI models 120, which in turn can generate the outputs for these fields.

The field 408 can contain brand positioning content that defines how the entity differentiates itself in the marketplace and establishes its value proposition for content creation purposes. The field 410 can present brand voice characteristics that determine the personality and character reflected in written communications. The field 412 can display brand tone attributes that guide the emotional approach and style used across different types of content and communication contexts. The AI orchestration platform 102 can use the textual instructions configured in these fields as content generation requirements or constraints. For example, these configurations can be incorporated into prompts provided to the custom model 108 to facilitate that generated content conforms to the specified branding parameters.

While these branding elements can be automatically generated by the system through the orchestrated LLM processing, they can remain editable by the user to facilitate alignment with organizational requirements. These defined branding parameters can be used by the custom model 108 during subsequent content generation processes to facilitate consistency and alignment with the established brand identity across future content created through the system 100.

FIG. 4B illustrates an example of a user interface 420 for custom language model training and publication integration within the AI orchestration platform 102. The interface 420 shows the custom LLM tab 406 in an active state. This user interface 420 can provide a file upload area 422, via which a user can provide entity-specific training data to the AI orchestration platform 102. This data may include various document formats, such as research and development data, financial spreadsheets, accounting databases, marketing materials, and other proprietary content, as described with respect to the data sources 112 of FIG. 1, for the purpose of training the custom model 108.

The user interface 420 may also include a sidebar 424 that enables a user to manage connections to external content platforms. These platforms can be internet or intranet sites, systems, or services to which the client entity publishes content, such as blogs, website building sites (e.g., WordPress), social media sites, or customer relationship management (CRM) systems. The user interface 420 can provide capabilities, such as an interactive control 426, that facilitate establishing a connection to these external publishing platforms.

These connection can enable the AI orchestration platform 102 to both retrieve existing content from these platforms for the purpose of training the custom model 108 and to distribute newly generated content to them.

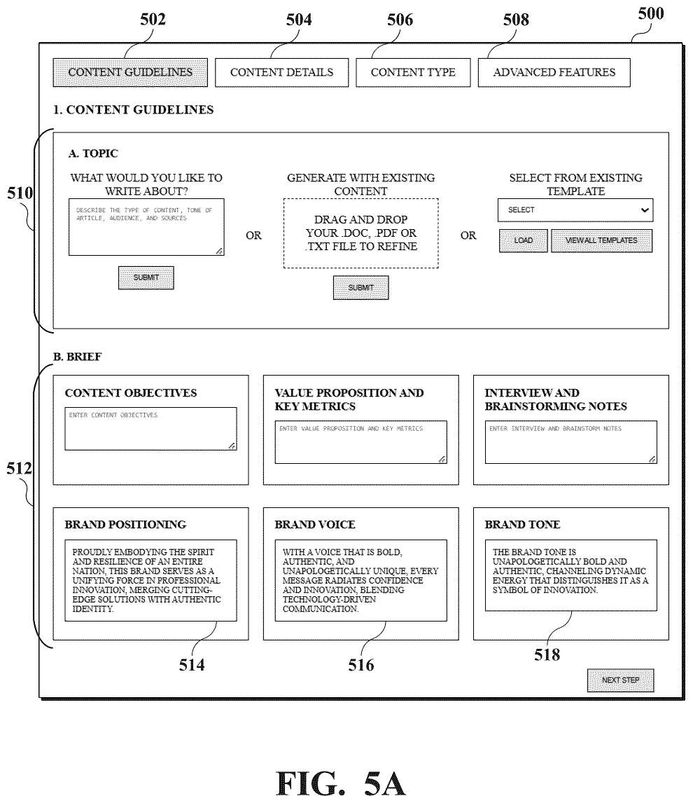

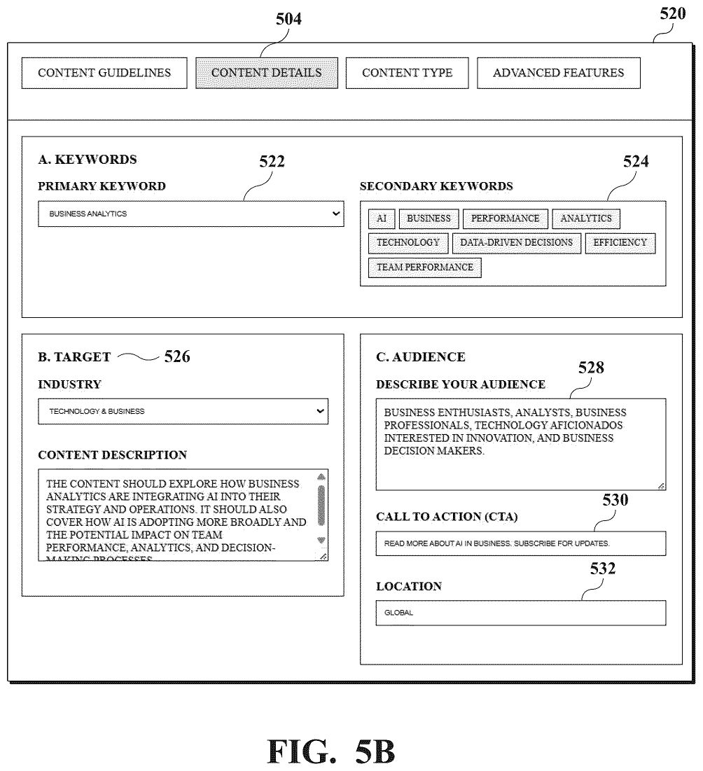

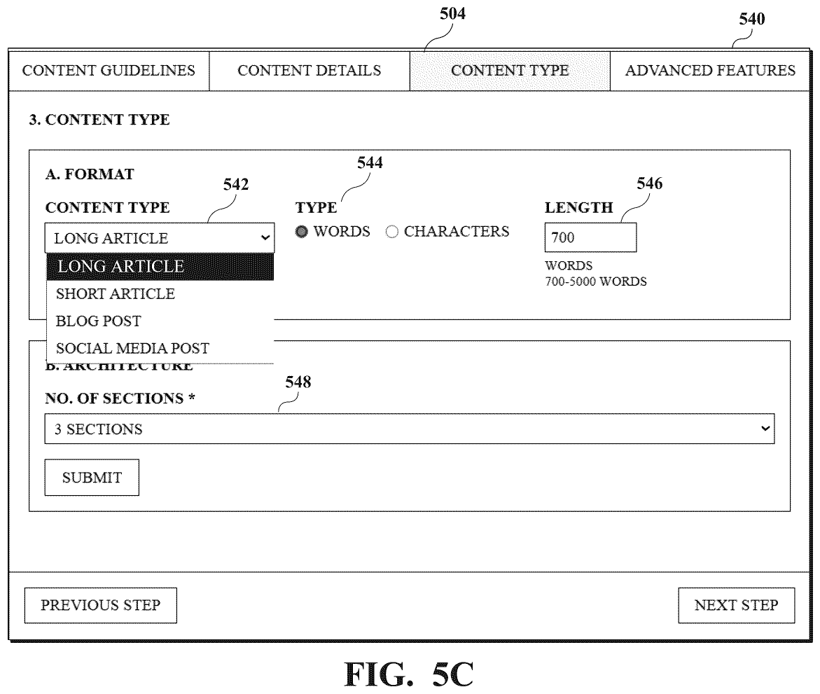

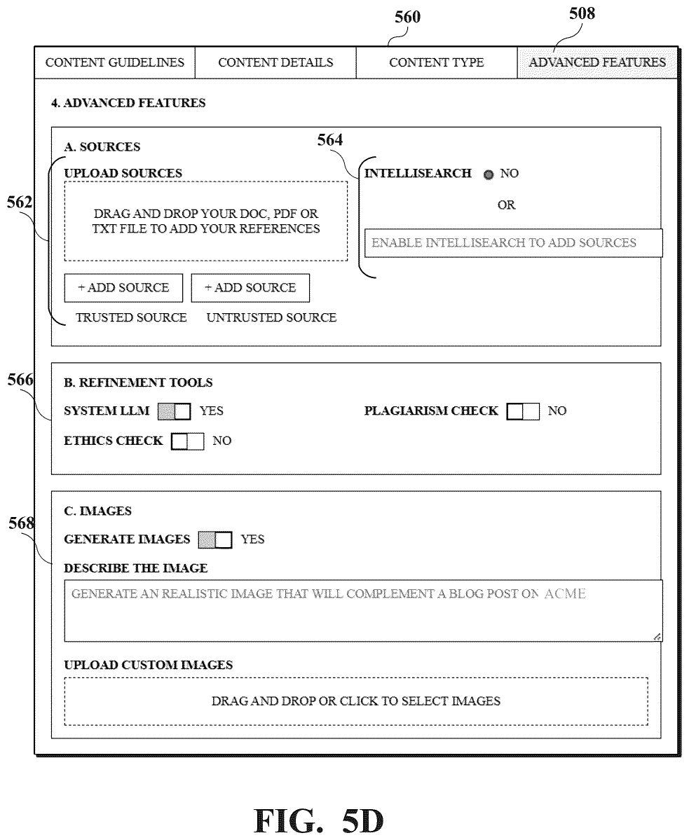

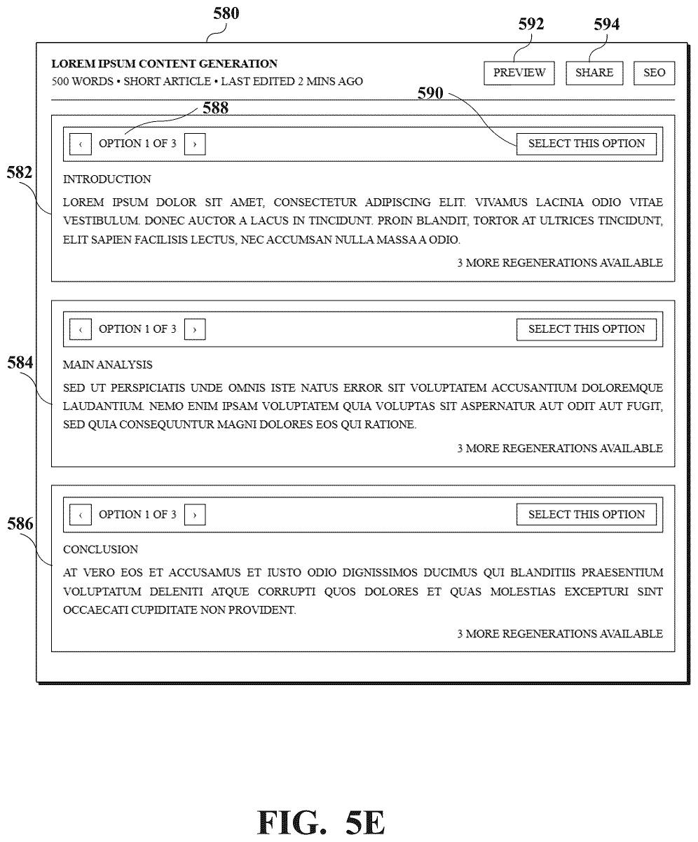

FIGS. 5A-5E illustrate user interfaces for providing input parameters and constraints that can direct the AI orchestration platform 102 to generate new content. FIG. 5A illustrates a user interface 500 for content guidelines that can implement a 4-step process including content guidelines (e.g., a step 502), content details (e.g., a step 504), content type (e.g., a step 506), and advanced features (e.g., a step 508). The user interface 500 is shown as displaying the active content guidelines (e.g., the step 502), which can provide input mechanisms for directing the content generation process. The content guidelines section (shown when the step 508 is selected) is shown as including two primary areas: a topic specification section 510 and a brief development section 512.

The topic specification section 510 can provide three alternative capabilities for topic input, enabling users to describe their content requirements through text input, upload existing content for refinement, or select from pre-existing templates. The brief development section 512 can contain multiple input fields for developing comprehensive content briefs, including areas for content objectives, value propositions and key metrics, and interview and brainstorming notes. This section can enable users to provide detailed contextual information that will inform the AI model sequencing and content generation process described in the disclosed techniques.

The brief development section 512 as shown as including three brand-related fields 514, 516, and 518 that may be pre-populated based on the brand positioning field 408, the brand voice field 410, and the brand tone field 412, respectively, described in FIG. 4A. While these fields can inherit the branding parameters of the entity defined during the initial setup process, they can remain editable and can be further modified for creating this particular content, allowing for content-specific customization while maintaining overall brand consistency. This approach can enable the custom model 108 to apply both general organizational branding and specific content requirements during the generation process described in the system workflows.

FIG. 5B illustrates a user interface 520 that can enable entry of additional content generation parameters following the content guidelines established in FIG. 5A. The user interface 520 can represent the second step (content details step 504) in the multi-step content generation process, where users provide specific targeting and audience parameters that will direct the system's AI orchestration capabilities.

The interface 520 can include a keywords section that facilitates specification of primary and secondary keywords for content optimization. A primary keyword field 522 can enable users to specify a main focus term, while a secondary keywords area 524 can enable entry of multiple related terms that will inform the AI model sequencing process. These keyword fields may be automatically populated through processing by multiple LLMs in a determined sequence. The AI orchestration platform 102 may process initial content parameters through a sequence of three LLMs, where a first LLM's output serves as input to a second LLM, the second LLM's output serves as input to a third LLM, and the output of the third LLM can provide keyword recommendations. In an alternative implementation, keywords may be collected separately from different LLMs operating in parallel, with the results subsequently combined through a union process to generate comprehensive keyword sets.

A target section 526 can be configured to enable input mechanisms for industry specification and content description parameters. An industry field can enable users to select or specify a relevant business sector, which can inform the orchestration model 116 in determining AI model sequences based on industry-specific performance data. A content description area can enable detailed specification of the subject matter and strategic objectives, providing contextual information that guides both the external LLM processing and the custom model 108 personalization.

An audience section 528 can include fields for detailed audience specification that will influence content tone, complexity, and strategic messaging. The audience section 528 enables users to define target demographic characteristics, professional backgrounds, and interest areas that inform content generation parameters. The audience specifications can impact the selection of AI model sequences, as different audience types may require different processing approaches optimized for specific communication styles and technical depth levels.

A call to action section 530 can provide input capabilities for specifying desired user behaviors or responses that the generated content should encourage. This field can enable definition of specific conversion objectives that will be incorporated into performance metrics tracking by the metric generator 114, creating measurable outcomes for the adaptive feedback loop described in the system's continuous improvement capabilities.

A location section 532 can enable geographic targeting specification, enabling content customization for specific markets, regions, or regulatory environments. For example, location parameters can be set to specific cities (e.g., San Francisco), states (e.g., North Dakota), regions (e.g., the Midwest), or larger territories (e.g., Eastern Europe, Global). These location parameters can inform both content generation strategies and compliance considerations. For instance, content may be tailored to use regional dialects or cultural references relevant to a specific market, such as the Midwest. For industries such as healthcare and legal services, this capability may be of interest for addressing region-specific regulatory requirements, such as conforming to different data privacy laws in Eastern Europe versus North Dakota, or cultural considerations that impact content effectiveness and compliance.

FIG. 5C illustrates a user interface 540 for content type specification within the AI orchestration platform 102, representing the third step (content type step 506) in the multi-step content generation process. The interface 540 can enable users to define structural and formatting parameters that will guide the system's content generation and LLM orchestration processes.

The interface 540 can include a format section that provides content type specification capabilities. A content type dropdown field 542 can enable selection between different content formats, with “LONG ARTICLE” shown as the selected option in an expanded dropdown menu displaying additional options including “SHORT ARTICLE,” “BLOG POST,” and “SOCIAL MEDIA POST.” The system can support various content types ranging from short articles of approximately words with a small number (e.g., three) sections to comprehensive documents of 8,000 to 9,000 words with up to fifteen different sections or chapters or more.

A type selector 544, which can be implemented as a dropdown menu or similar interactive element, enables the specification of measurement units, such as words, characters, or paragraphs, for defining content length parameters. A length input field 546 enables a user to provide a numerical specification for the desired content length, such as “500” words or “3” paragraphs.

An architecture section can include a sections dropdown field 548 that enables specification of document structure, such as the number of sections to be generated. The AI orchestration platform 102 may be pre-configured to present a predefined number of alternative content options, for example three, for each section. In some implementations, the user may specify a different number of alternatives to be generated. As further described herein, to generate three alternatives, the system 100 may select a predefined number of AI model sequences, such as 50, and generate content adhering to the architecture parameters section using all of these sequences. The system can then score the generated content from each sequence and present the top three highest-scoring content options to the user. The user may then select specific sections from each of the generated content options. This technical capability allows a user to combine preferred sections from multiple distinct outputs, which are then programmatically assembled into a final document.

FIG. 5D illustrates a user interface 560 for advanced features specification within the AI orchestration platform 102, representing the fourth step (advanced features step 508) in the multi-step content generation process. The interface 560 can enable users to configure source control, content refinement tools, and image generation parameters that enhance the system's retrieval-augmented generation capabilities and content quality optimization.

The interface 560 can include a sources section with a set of controls 562 that enable users to specify trusted and untrusted sources for content generation. An upload sources area can provide a drag-and-drop interface for users to upload documents in various formats to serve as reference materials. The system can enable users to categorize uploaded sources as either trusted or untrusted through dedicated controls, implementing source control capabilities described in the disclosed techniques. This source categorization can be used to direct the RAG process to preferentially retrieve contextual information from trusted sources, automatically generate citations for information drawn from those sources, and actively exclude or flag content derived from untrusted sources, which enhances the factual accuracy and verifiability of the generated content.

This approach configures the system 100 to avoid hallucination by providing a curated, factual basis for the generated text. For example, a user can specify a reputable medical web site as a trusted source for healthcare content and a tabloid magazine as an untrusted source. This source categorization configures the system 100 at the time of content generation to direct the retrieval-augmented generation (RAG) process. The system 100 is configured to retrieve information preferentially from the trusted sources to construct prompts for the generative model. The system 100 is also configured to exclude information from untrusted sources when retrieving contextual information.

A set of controls 564 can enable users to activate intelligent search functionality that causes the system to perform automated web crawling to identify recent content, postings, articles, and references related to the entity and the content to be generated. When enabled, this feature can allow the system to discover current information sources and present them to users for classification as trusted, untrusted, or to be ignored. Based on the system's operation described in the disclosed techniques, this crawling process can provide a revolving list of recent sources based on recency, enabling users to access up-to-date information while maintaining control over source reliability. For example, the system may identify recent social media posts, news articles, or industry publications related to the content topic and present them for user evaluation and categorization.

The sources identified through this web search functionality are intended to provide the latest information, with the system presenting sources based on recency to ensure up-to-date information is available.

An area 566 can include refinement tools controls that direct the system to determine whether to perform various content quality and compliance functions. A system toggle can enable activation of the custom model 108 for content refinement based on entity-specific training data and performance patterns. A plagiarism check control can enable detection of potential copyright infringement or content similarity issues, performing checks against other articles within the user's environment, competitor content, and publicly available sources. An ethics check control can enable compliance verification for regulated industries, identifying potentially problematic language that could violate industry regulations, such as preventing the use of terms that could trigger regulatory issues in pharmaceutical or healthcare content.

An area 568 can provide image generation and management capabilities for multimedia content creation. An image generation toggle can enable automatic image creation to complement the generated content. A description field can enable users to specify image requirements and characteristics for automated generation. An upload section can provide a drag-and-drop interface that enables users to incorporate existing images into the content creation process, supporting the system's multi-modal content generation capabilities described in the disclosed techniques. These image integration features can enable the creation of comprehensive content that combines text, visual elements, and multimedia components optimized for various publication channels and audience engagement objectives.

FIG. 5E illustrates an example of a user interface 580 for reviewing and selecting content options generated by the AI orchestration platform 102. The user interface 580 can represent the culmination of the multi-step content generation process described in FIGS. 5A-5D, where the system presents multiple content options for user selection and refinement. The user interface 580 enables users to review different drafts, select preferred sections, and assemble a final document for publication.

The user interface 580 displays the generated content, organized into distinct sections. In the illustrated example, the user interface shows an introduction section 582, a main analysis section 584, and a conclusion section 586. These sections correspond to the number of sections requested by the user, for example, a short article with three sections.

Associated with each content section is a control, such as control 588, which enables the user to cycle through the different content options generated for that section. The AI orchestration platform 102 may generate three different options for each section, with each option produced by a unique AI model sequence. This allows the user to compare and choose from various versions of the same section, such as the introduction.

A control 590, labeled “SELECT THIS OPTION,” enables the user to choose a particular content option for a given section. This user selection acts as a form of secondary user input that guides the final assembly of the document. The user can select their preferred option for each section based on criteria such as tone, style, or technical depth. These selections are logged and stored in a datastore for future model training and optimization.

A control 592, labeled “PREVIEW,” enables the user to view the complete, assembled content based on their selections across all sections. This feature provides an integrated look at the final document before it is finalized. Finally, a control 594, labeled “SHARE,” enables the user to publish the assembled and finalized content to one or more media outlets, such as a company blog, social media platforms, or other publishing channels. This action triggers the system's performance tracking mechanisms to collect real-world metrics for the adaptive feedback loop.

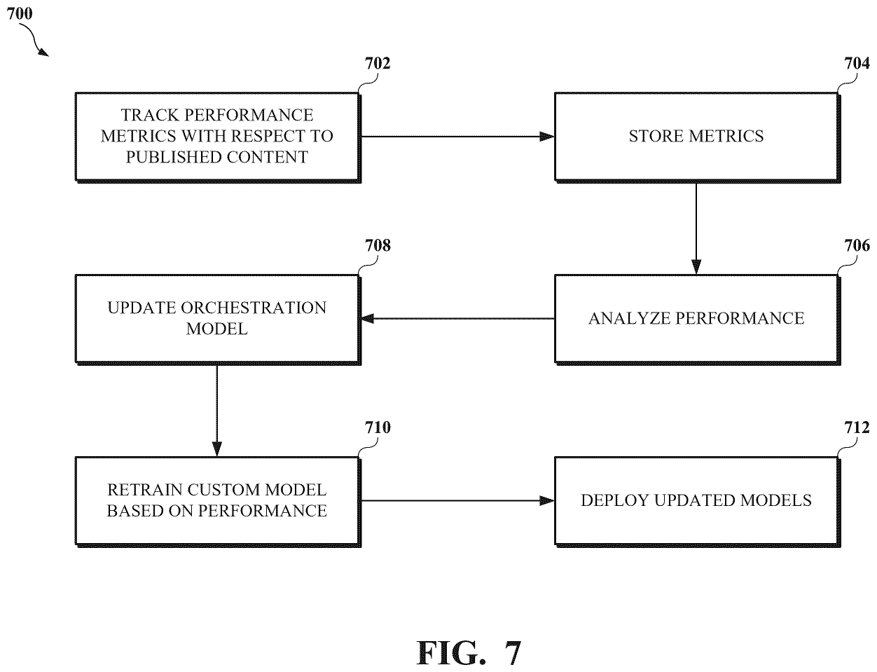

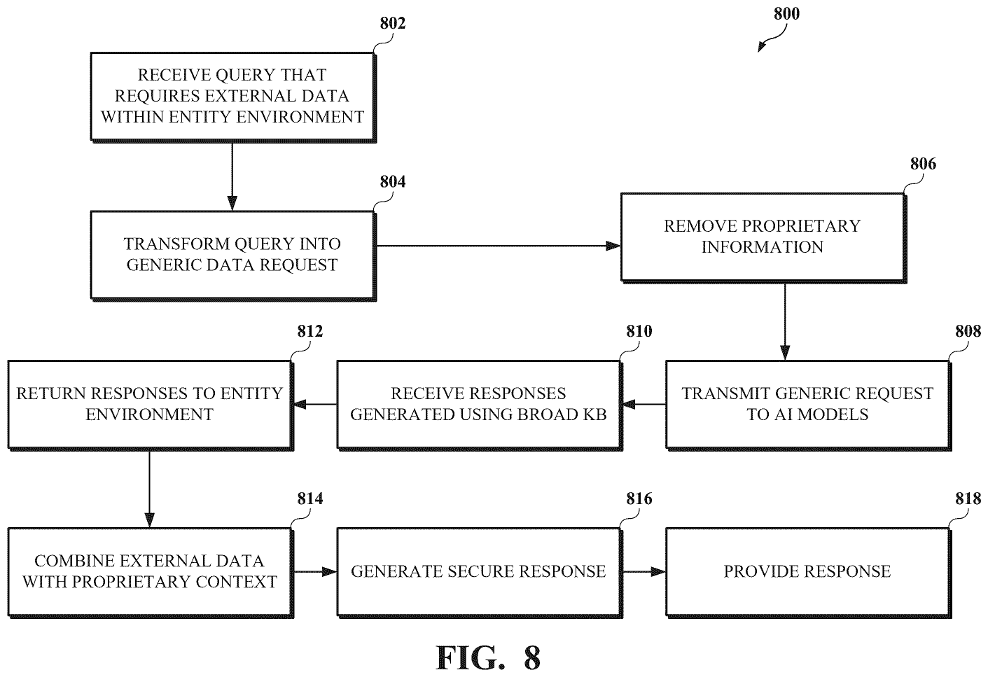

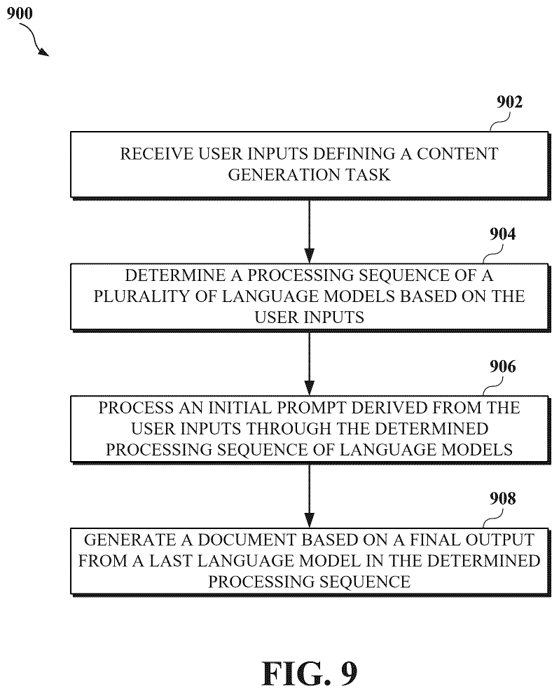

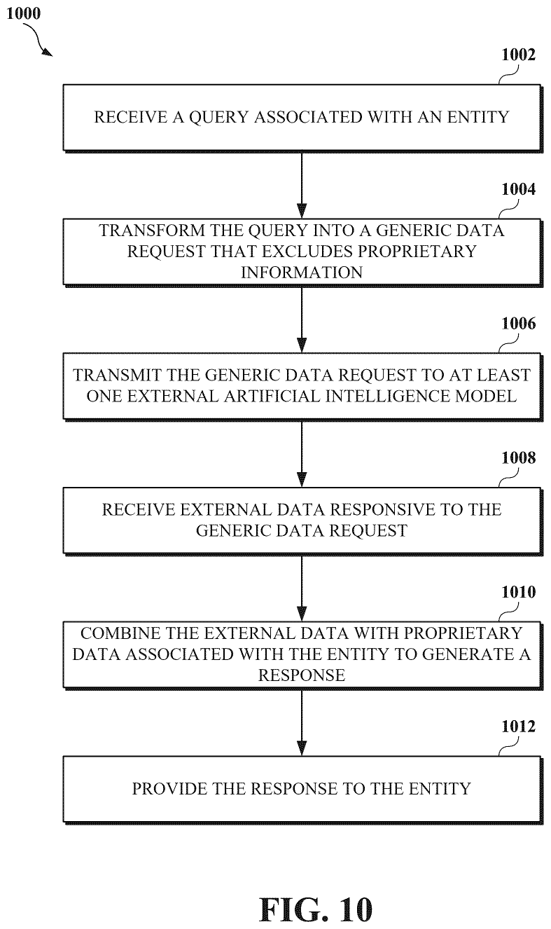

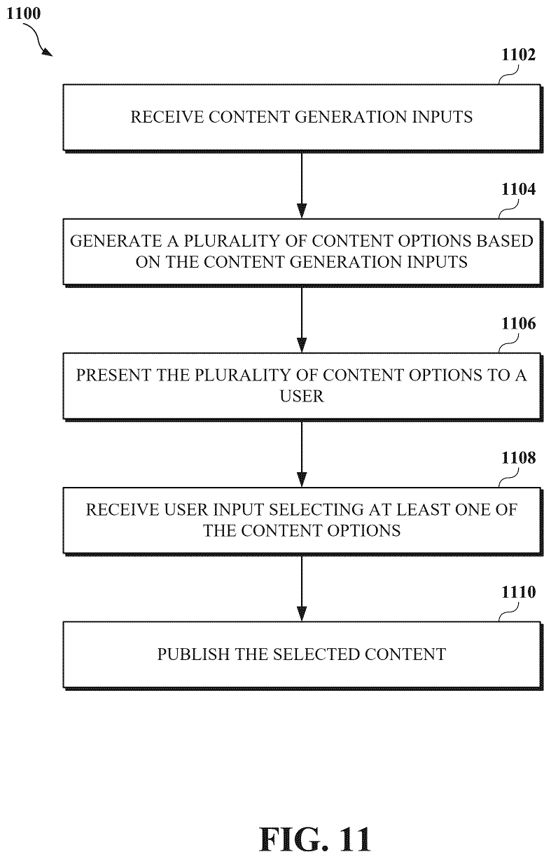

To further describe some implementations in greater detail, reference is next made to examples of techniques which may be performed by or using a system for generating content using orchestrated sequences of AI models. FIG. 6 is a flowchart of an example of a technique 600 for generating and publishing optimized content. FIG. 7 is a flowchart of an example of a technique 700 for adaptively optimizing artificial intelligence models based on performance feedback. FIG. 8 is a flowchart of an example of a technique 800 for secure artificial intelligence processing of data. FIG. 9 is a flowchart of an example of a technique 900 associated for generating a document using a sequence of AI models. FIG. 10 is a flowchart of an example of a technique 1000 associated with a method for processing data using artificial intelligence. FIG. 11 is a flowchart of an example of a technique 1100 associated with a method for generating content using artificial intelligence.

The techniques 800 through 1100 can be executed using computing devices, such as the systems, hardware, and software described with respect to FIGS. 1-5E. The techniques 800 through 1100 can be performed, for example, by executing a respective machine-readable program or other computer-executable instructions, such as routines, instructions, programs, or other code. The steps, or operations, of each of the techniques 800 through 1100, or another technique, method, process, or algorithm described in connection with the implementations disclosed herein can be implemented directly in hardware, firmware, software executed by hardware, circuitry, or a combination thereof.

For simplicity of explanation, each of the techniques 800 through 1100 is depicted and described herein as a respective series of steps or operations. However, the steps or operations of each of the techniques 800 through 1100 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring to FIG. 6, at 602, the technique 600 can receive a request or content generation parameters. These parameters can be user-defined inputs that specify desired characteristics of the content to be generated. For example, the client 101 may submit content generation parameters to the AI orchestration platform 102, including a topic such as “braces for children,” a target audience of “busy moms with 2 kids,” in the “San Francisco” area, a desired tone, and a content type such as a short article or a social media post. The parameters may also include primary keywords, secondary keywords, target audience specifications, and content type requirements.

The technique 600 may receive parameters specifying the number of sections for the content, such as three sections for a short article or ten to fifteen sections for comprehensive documents up to 8,000 or 9,000 words. The parameters may also include content objectives, value propositions, key metrics for measuring success, and expert notes or brainstorming materials that inform the generation process. An alternative implementation may include receiving these parameters via an API call from another software system, or by having the system parse an existing document to automatically extract the relevant parameters.

At 604, the technique 600 can determine multiple AI model sequences. The orchestration model 116, shown in FIG. 1, may perform this step by analyzing the received content generation parameters and selecting several different ordered sequences of the available AI models 120. Each sequence can represent a multi-step pathway for refining content based on historical performance data from a comprehensive corpus of published content (e.g., 30,000 different articles) across various industries. The technique 600 may analyze performance data using scoring systems based on criteria for performance, including readability, search engine optimization, tone, originality, and audience engagement metrics.

For example, for a legal brief, the orchestration model 116 may determine one sequence that prioritizes a model known for formal writing followed by a model for citation checking, and a second sequence that starts with a creative model followed by a structural model. The technique 600 may generate three to five different AI model sequences, each optimized for different performance criteria such as targeting a specific demographic, such as mothers residing in a particular metropolitan area whose children present with specific orthodontic conditions, or dementia patients requiring specialized communication approaches. In some implementations, a user may manually select or override the AI model sequences, or the technique 600 may dynamically determine sequences based on real-time performance feedback.

At 606, the technique 600 can generate multiple content options via the determined AI model sequences. The technique 600 can process an initial prompt derived from the content generation parameters through each of the different sequences. In each sequence, the output from a first AI model can serve as the input to a subsequent AI model, enabling for iterative refinement. For instance, three different sequences of the available AI models 120 (e.g., three sequences of LLM models) could be executed in parallel to produce three distinct drafts or content options for a single section of an article.

The technique 600 can generate multiple content options for each section of the document, with each content option produced using a different computationally-determined AI model sequence optimized for performance metrics. For example, if the content includes three sections, the system may generate three different options for each section, resulting in nine total content variations that users can mix and match. This technical process can leverage the complementary strengths of various models to create a diverse set of high-quality outputs.

At 608, the technique 600 can refine and personalize the multiple content options. The drafts generated in step 606 can be processed by the custom model 108 (or the agents 110, as the case may be) within the secure entity environment 104. The custom model 108, having been trained on the client entity's proprietary data, can inject the specific brand voice, style, and contextual knowledge into each option. For example, if the client is a healthcare provider, the custom model 108 can facilitate the language used in each content option aligns with their established patient communication guidelines and avoids non-compliant terms like “miracle drug.”

This step represents a PGR process, distinct from RAG. As already mentioned, while RAG retrieves raw data or documents to augment prompts before generation, PGR takes fully-formed content already generated by external AI models and refines it using the proprietary context of the custom model 108.

At 610, the technique 600 may score the multiple generated content. Before presenting the options to the user, the technique 600 may use an internal scoring mechanism, potentially leveraging the orchestration model 116, to rank each of the refined content options based on predicted performance. The scoring may be based on criteria such as readability, originality, tone, and predicted SEO performance, benchmarked against historical data stored in the datastore 113. For example, three generated article introductions may be scored, with a highest-scoring option presented most prominently to the user.

The scoring process may incorporate metrics such as originality, tone, readability, SEO score, citation counts, and other structural factors derived from tools like industry-standard marketing and SEO analytics platforms. The technique 600 can create a vectorized map to determine how new content compares to known good and bad examples from the training dataset, potentially performing principal component analysis to position content within a spectrum of performance scores. The scoring algorithm can learn the relationship between text structures and performance metrics, enabling prediction of how well an article might perform based on similarity to historical high-performing content.

The scoring system employs vectorized analysis that converts textual content into numerical vector representations using natural language processing techniques such as word embeddings, sentence transformers, or contextual language model encodings to position new content within a multi-dimensional space of known content performance. Each content piece can be transformed into a high-dimensional vector where semantic similarity, stylistic characteristics, structural patterns, and performance indicators are encoded as numerical coordinates within this mathematical space.

Each generated content option, including both selected and unselected variants, receives a predicted performance score based on its proximity to known high-performing and low-performing examples in the training database. The system utilizes principal component analysis to identify the closest matches across the scoring criteria. Distance metrics such as cosine similarity or Euclidean distance are calculated between the new content vectors and historical content vectors to determine performance predictions based on the mathematical relationships within the vector space.

For example, when generating three options for each of three sections, all nine content pieces are scored, creating a comprehensive dataset that captures not only what users select but also what they reject. This scoring of all generated options, regardless of selection, provides valuable counterfactual data for model refinement.

At 612, the technique 600 can obtain a content option selection. The multiple, refined content options can be presented to the client 101 through a user interface. The user can then review the different versions and select a preferred option for each section of the document. For example, for a three-section article, the user might select option 2 for the introduction, option 1 for the body, and option 3 for the conclusion. This user interaction can be a form of secondary user input that guides the final assembly of the document.

The interface may present three different content options for each section of a document, enabling users to select their preferred option for each section based on tone, style, technical depth, or strategic alignment. The system may provide preview capabilities, side-by-side comparisons, and performance prediction summaries to inform selection decisions. Users may select complete content options or combine elements from different options to create hybrid solutions that best meet their specific requirements.

At 614, the technique 600 can record the scores and selections. The choice made by the user in step 612 can be logged and stored in the datastore 113. This recorded data can include not only the selected content but also the context, such as the content generation parameters and the specific AI model sequence that produced the chosen option. This can create a dataset linking user preference to specific generation methodologies. To illustrate, the technique 600 can record that for articles targeting a “technical audience,” the user consistently prefers outputs from LLM Sequence 2.

The recorded data may include metadata about content structure, stylistic elements, technical depth, and strategic alignment that influenced user selection decisions. To illustrate, the technique 600 may capture that users consistently select content with shorter paragraph structures for mobile audiences, prefer active voice constructions for technical documentation, or favor specific terminology choices that align with brand guidelines. Additional metadata may include semantic complexity scores, readability indices, keyword density measurements, citation frequency patterns, and engagement prediction factors derived from content characteristics.

Such information can become training data for refining both the orchestration model 116 and the custom model 108, enabling continuous improvement in content generation quality and user satisfaction through iterative training loops based on performance feedback. The technique 600 may analyze patterns such as user preference for introductory sections generated by a first AI model sequence versus body content generated by a different sequence, or correlations between content structural elements and subsequent performance metrics, enabling the models to learn which combinations of content characteristics and generation approaches produce optimal results for specific organizational contexts.

The recorded data creates a database linking user choices to specific contexts. For instance, when a user selects option two for section one of an article targeting a specific audience with particular keywords and location parameters, this choice is categorized as an ‘interim choice’ rather than immediately classified as good or bad. The AI orchestration platform 102 recognizes that true performance validation only occurs after publication. This interim classification allows the system to later correlate user preferences with actual performance outcomes, distinguishing between what users prefer and what actually performs well-two metrics that may not always align.

At 616, the technique 600 can assemble and prepare the final content for publication. Based on the user's selections from step 612, the technique 600 can programmatically combine the chosen sections into a single, cohesive document. This step may also include final checks for plagiarism or compliance, and the integration of any user-uploaded images or sources. For instance, the selected introduction, body, and conclusion can be stitched together, and a plagiarism check can be run before the document is finalized.

The assembly process may include additional refinement steps such as transition smoothing between selected sections, citation verification and formatting, compliance checking for industry regulations, and final optimization for publication channels. The technique 600 may support publication to multiple media outlets simultaneously, adapting format and style requirements for different platforms such as corporate websites, social media channels, industry publications, or regulatory submission systems.

At 618, the technique 600 can publish the final content. The assembled document can be published to one or more media outlets as directed by the user. This could involve posting the article directly to a company's blog via a Content Management System (CMS) integration, scheduling it for social media platforms, or exporting it as a file for manual distribution.

The technique 600 may be configured to coordinate simultaneous publication across multiple channels while maintaining version control and facilitating consistent messaging. Publication can trigger the initiation of performance tracking mechanisms that will provide data for future model training and optimization cycles, enabling the AI orchestration platform 102 to measure real-world content effectiveness and incorporate this feedback into subsequent content generation processes. An alternative implementation may include sending the content to a compliance officer for final review before it is made public.

The technique 600 can include measuring performance metrics of the published content and training a custom language model based on the user selection data and the measured performance metrics. In some implementations, the metric generator 114 shown in FIG. 1 may track real-world performance indicators such as user engagement rates, search engine rankings, conversion rates, and click-through rates associated with the published content. The system may integrate with web analytics platforms, social media monitoring tools, and business intelligence systems to collect comprehensive performance data across multiple channels and timeframes.

This performance data, combined with the recorded user selection preferences, can enable the training of the custom model 108 to better understand what content characteristics lead to success for the specific client entity. The system can train the custom model on articles that performed well rather than training on all published content, creating an iterative process that focuses learning on demonstrated success patterns. The trained custom AI model can then be incorporated into subsequent content generation processes, creating an adaptive feedback loop that continuously improves content quality and performance prediction accuracy.

Referring now to FIG. 7, at 702, the technique 700 can track performance metrics with respect to published content. This step can follow the publication of the final content as described in step 618 of FIG. 6. For example, the metric generator 114 shown in FIG. 1 may monitor the various platforms where the content is live to collect data on its effectiveness, tracking one or more real-world performance metrics associated with the published initial document. In some implementations, the technique 700 may track performance metrics including user engagement rates on social media platforms such as likes, shares, and comments, search engine rankings for target keywords, website conversion rates, click-through rates from email campaigns, and business-specific key performance indicators that measure content effectiveness.

The performance metrics may include a wide range of quantifiable measures of content effectiveness. Examples can include conversion statistics such as the number of users who completed a desired action like signing up for a newsletter or scheduling appointments, and engagement metrics that assess viral potential of marketing content. For instance, for a marketing article published on a blog, the metric generator 114 may track the number of leads generated through a call-to-action link within the article, or measure whether published articles about dental braces targeting busy moms with two kids achieved higher engagement rates compared to previous content.

The technique 700 may track business-specific conversion metrics such as the number of doctor appointments scheduled after reading a generated healthcare article, legal consultation requests generated from published legal content, or product purchases resulting from marketing materials across different publication channels including social media platforms, email campaigns, and corporate websites. As another example, the technique 700 may include tracking academic citation counts for scholarly content, patient outcome improvements for healthcare materials, or compliance scores for regulatory documents.

At 704, the technique 700 can store the collected metrics. The performance data tracked in the previous step can be transmitted to and stored in the datastore 113 shown in FIG. 1. The metrics can be associated with the specific content that produced them, as well as the user selections and generation parameters that were recorded in step 614 of FIG. 6. This can create a rich, contextualized dataset for analysis. For example, a record in the datastore 113 may indicate that a specific article, generated with a particular AI model sequence and refined with a certain style, achieved a 20% higher engagement rate than an average.

The technique 700 may be configured to create detailed logs that correlate specific performance outcomes with content characteristics, stylistic elements, technical depth, and strategic alignment factors. The stored data may include correlation data between predicted performance scores and actual measured results, enabling the AI orchestration platform 102 to improve its prediction accuracy over time.

At 706, the technique 700 can analyze the stored performance data. A processing component, which may be part of the orchestration model 116 or a separate analysis engine, can examine the data in the datastore 113 to identify patterns and correlations. The analysis can aim to determine the characteristics of high-performing content versus low-performing content. For example, the AI orchestration platform 102 may analyze the stored data and determine that articles written in an active voice with shorter paragraphs result in higher search engine rankings for a particular client entity. The AI orchestration platform 102 may evaluate which content characteristics, AI model sequences, and user selection patterns correlate with successful outcomes.

The analysis process may incorporate vectorized analysis to compare published content against historical performance databases, identifying structural and stylistic similarities that correlate with success. The technique 700 may determine that content targeting healthcare professionals performs better when generated using specific AI model sequences that my implicitly prioritize factual accuracy followed by readability optimization, or that articles with certain structural patterns achieve higher engagement rates. This analysis can enable the AI orchestration platform 102 to move beyond generic content generation approaches toward evidence-based optimization strategies tailored to specific audience segments and performance objectives.

For instance, the analysis may reveal that articles processed through a sequence of LLM1-LLM2-LLM3 achieve higher search engine rankings for technical audiences, while a sequence of LLM4-LLM2-LLM1 produces superior engagement rates for general consumer content. The system may also identify that certain LLM permutations excel at specific content sections, such as LLM1 generating superior introductions while LLM2 produces more effective conclusions for the same target audience. These granular insights can enable section-specific optimization that goes beyond document-level sequence selection to optimize individual content components.

The analysis incorporates both selected and unselected content options to create a comprehensive performance model. When content is published and performs well, the system not only reinforces the patterns of the selected options but also marks the unselected alternatives as less desirable for that specific client context-even though those same options might perform well for different clients. This client-specific performance mapping enables the system to learn that what constitutes ‘good’ content varies by organization. The custom SLM, from a weighting perspective, carries larger influence than the sequence of large language models, ensuring that client-specific preferences and performance patterns take precedence over general optimization rules.

The technique 700 may include using machine learning techniques to automatically identify complex success patterns and optimize content generation strategies. These techniques may include clustering algorithms to group content based on SEO performance metrics including search engine rankings, keyword optimization effectiveness, backlink generation potential, and organic traffic conversion rates. The technique 700 may also employ regression analysis to correlate content structural elements with SEO performance indicators such as click-through rates, time-on-page metrics, and search result positioning, and statistical correlation analysis to identify causal relationships between specific content characteristics and SEO outcomes such as correlations between paragraph length, keyword density, and search ranking performance.

The technique 700 may also implement pattern recognition algorithms that can detect emerging trends in content performance (e.g., SEO performance and content engagement metrics), thereby enabling proactive adjustments to generation strategies that optimize for search engine visibility and user engagement simultaneously.

At 708, the technique 700 can update the orchestration model. Based on the insights from the performance analysis, the logic of the orchestration model 116 can be refined. This update may involve adjusting the algorithms used to determine the sequence of AI models for future content generation tasks. To illustrate, if the analysis shows that a specific sequence of LLMs such as AI model 122B followed by AI model 122A produces content that performs well for a “technical audience,” the orchestration model 116 may be updated to assign a higher weighting to that sequence when similar content generation parameters are received.

The orchestration model 116 may incorporate learned heuristics that identify defining characteristics for different industries, such as media and sports entertainment, to determine processing sequences for targeting different patient groups or audience segments. To illustrate, the AI orchestration platform 102 may determine that content targeting healthcare professionals achieves optimal results when processed through a sequence starting with LLM1 for initial structural development, followed by LLM4 for analytical refinement and fact-checking, and concluding with LLM10 for domain-specific medical terminology optimization. Alternatively, for legal content, the system may prioritize a sequence beginning with LLM3 for legal reasoning, followed by LLM2 for citation verification, and ending with a specialized legal model for compliance checking.

The technique 700 may update sequence selection criteria based on performance data suggesting that different approaches are relevant for specific use cases, such as legal documents targeting regulatory compliance achieving better outcomes when processed through specific sequences. The order dependency of AI model sequences can be a factor, as changing the sequence order from one AI model sequence to another can produce measurably different content quality and engagement outcomes. This sequence sensitivity can enable the system to fine-tune processing workflows based on empirical performance evidence.

Some implementations may include reinforcement learning systems that continuously optimize AI model selection based on performance feedback, genetic algorithms for exploring sequence combinations, or dynamic orchestration algorithms that adjust sequences based on intermediate performance predictions. The technique 700 may also implement conditional sequencing that adapts the processing path based on content type, target audience characteristics, or real-time quality assessments at intermediate stages of the generation process.

At 710, the technique 700 can retrain the custom model based on performance. This step can involve refining the artificial intelligence model by retraining it using the tracked performance metrics and stored user selections. This training process, which may incorporate user selection data and measured performance metrics, can allow the custom model 108 to learn the stylistic, structural, and contextual attributes that correlate with success for the specific client entity. For example, the text from high-performing published articles may be used as a positive training set, reinforcing the patterns that led to their success. In some implementations, the technique 700 may be configured to focus training on articles that performed well, creating an iterative process that emphasizes demonstrated success patterns.

The retraining process may incorporate both user selection data and measured performance metrics to learn user preferences and content performance patterns. This process refines the AI model by updating its parameters based on what content characteristics, such as tone, structure, or strategic messaging, lead to success for the specific client. For instance, if published articles achieve higher conversion or engagement rates, the custom model 108 can learn to incorporate those successful elements into future content. The newly refined custom model 108 can then be used for subsequent content generation tasks, ensuring that learnings from past performance are applied to improve future outputs. This creates an adaptive feedback loop that optimizes content based on empirical evidence of what works for the client organization, thereby increasing the likelihood of achieving desired performance outcomes. Implementations of this retraining may include incremental or online learning, federated learning, or reinforcement learning from human feedback.

For new entities without publishing history, the AI orchestration platform 102 may leverage published content (e.g., articles) from similar companies in the same industry as proxy training data. This bootstrapping approach enables the custom model to begin with industry-relevant patterns while awaiting client-specific performance data. As the entity publishes content and performance metrics accumulate, the model progressively shifts from industry-general patterns to client-specific optimizations. The AI orchestration platform 102 continuously compares predicted scores against actual performance, refining its scoring algorithm with each publication cycle. This creates a feedback loop where predicted data, expected data based on user selections, and known performance data converge to improve future predictions

At 712, the technique 700 can deploy the updated models. After the orchestration model 116 has been updated and the custom model 108 has been retrained, the new versions of these models can be deployed into the production environment of the AI orchestration platform 102. This deployment can make the improved models available for the next content generation request from the client 101. The deployed models can enable future content generation requests to benefit from improved AI model sequence selection and enhanced personalization based on learned performance patterns.

The deployment can create an adaptive feedback loop for content optimization that reflects both user preferences and actual real-world outcomes, facilitating that the system continuously evolves to better serve client objectives. The updated models can be incorporated into subsequent content generation processes described in FIG. 6, creating a continuous feedback loop that improves content quality and performance prediction accuracy over time. Alternative implementations could involve a canary deployment where the updated models are initially rolled out to a small subset of requests to monitor their performance before full-scale deployment, A/B testing frameworks to validate model improvements, or rollback mechanisms that enable quick reversion if updated models underperform compared to previous versions.

The technique 700 can demonstrate how the disclosed system creates a self-improving artificial intelligence platform that can learn from real-world content performance to enhance future generation capabilities. The integration of performance tracking, analysis, and model retraining can enable continuous optimization that goes beyond traditional static AI systems. This adaptive approach can be configured to facilitate improvements in content generation quality over time while maintaining alignment with organizational objectives and user preferences, thereby providing an adaptive framework for AI-powered content creation technology.

Referring now to FIG. 8, at 802, the technique 800 can receive a query that requires external data within the entity environment. For example, the custom model 108, operating within the secure entity environment 104 shown in FIG. 1, can receive a query from the client 101 that cannot be answered using only the entity's proprietary data and requires broader, external context. In some implementations, a user at a pharmaceutical company might ask the system to “Compare our unreleased drug, ‘CardioLorem,’ against the top three competing drugs currently on the market,” or a legal firm might request “Analyze the competitive landscape for our confidential litigation strategy in intellectual property cases.”

The custom model 108 may determine that external information is needed to provide a comprehensive response while maintaining confidentiality of internal data. The technique 800 may optionally establish direct internet connectivity when required to access real-time data sources, current market information, or updated regulatory databases that are not available through standard AI model interfaces in response to such requests from the custom model 108. This internet connectivity capability enables the technique 800 to retrieve time-sensitive information such as current stock prices, recent regulatory changes, or breaking industry news for subsequent integration by the custom model 108, while maintaining the same security protocols and query transformation processes described herein.

The query may originate from various problem solving agents 110 within the entity environment 104 that require external data to complete their specialized workflows, such as revenue cycle management for healthcare claims processing or competitive analysis for pharmaceutical drug development. Alternative implementations may include queries from automated systems, enterprise resource planning platforms, or customer relationship management systems that require external market intelligence to inform internal decision-making processes.

At 804, the technique 800 can transform the query into a generic data request. This step can be a technical process handled by the bridging model 118 within the AI sandbox 106 shown in FIG. 1. The purpose of this transformation can be to rephrase the query in a way that it can be answered by external systems without revealing any confidential information and/or to exclude any text that may reveal the identity of the entity. The technique 800 can identify the parts of the query that relate to proprietary information and the parts that relate to public information. For example, the bridging model 118 might employ natural language processing techniques to identify and abstract proprietary elements such as company names, product codes, financial figures, strategic information, and personally identifiable information (PII) including researcher names, employee contact information, email addresses, phone numbers, and individual identifiers before formulating external queries.

The transformation process can facilitate that specific queries containing proprietary information are converted into generic requests suitable for transmission to external AI systems while preserving query intent and requirements. The bridging model 118 may utilize semantic abstraction techniques that preserve meaning while removing identifying details, or template-based transformation systems that map proprietary queries to predefined generic formats. This technical process can represent a secure query transformation that excludes information specific to the client entity while maintaining the analytical requirements to obtain relevant external data.

At 806, the technique 800 can remove proprietary information from the request as and when required. Removing proprietary information, as used herein, encompasses techniques such as redaction, obfuscation, masking, semantic abstraction, or any other technique that prevents disclosure of sensitive information while preserving analytical context.

As such, this step can programmatically abstract or strip any client-specific identifiers, confidential project names, or sensitive data points from the query formulated in the previous step. The technique 800 may employ selective redaction techniques that balance privacy protection with contextual preservation, as removing PII or proprietary information may result in some loss of context that could affect the accuracy or relevance of responses from external language models. The technique 800 may implement intelligent abstraction algorithms that replace specific identifiers with generic placeholders while maintaining semantic relationships and analytical requirements. Continuing the pharmaceutical example, “our unreleased drug, ‘CardioLorem,’” can be redacted, and the query can be reshaped to focus on the public-facing part of the request. This can result in a generalized external data request that excludes proprietary information specific to the client entity.

To illustrate, a query such as “Compare our Q3 pharmaceutical revenue against industry competitors” might be transformed into a generic request like “Provide Q3 pharmaceutical industry revenue benchmarks and competitive analysis data.” Alternative implementations may include multiple levels of abstraction, automated verification systems that validate information removal, or machine learning algorithms trained to identify and mask proprietary content across different industry domains and data types.

At 808, the technique 800 can transmit the generic request to the AI models. The now-anonymized request, for example, “Provide all public performance data, side effects, and pricing for the top three competing cardiology drugs on the market,” can be sent to one or more of the available AI models 120 shown in FIG. 1. This can be a stage where a request originating from the entity's query is processed outside the secure platform, and it contains no proprietary data. The orchestration model 116 may determine the optimal sequence of external AI models to process the generic request, utilizing machine learning algorithms trained on historical performance data to predict which combinations will produce the most comprehensive and accurate external data responses.

The technique 800 can maintain data isolation boundaries during this transmission, facilitating that the secure entity environment 104 remains protected while enabling access to the broad knowledge capabilities of external AI systems. Alternative implementations may include encrypted transmission protocols, distributed query processing across multiple external providers, or federated learning approaches that enable knowledge access without direct data transmission.

At 810, the technique 800 can receive responses generated using a broad knowledge base. The external AI systems can process the generic request and return information based on their publicly available training data. This response will contain comprehensive data about the requested subject matter but will have no knowledge of or context about the client entity's proprietary information. For example, the external response might include detailed market analysis of pharmaceutical competitors, regulatory approval timelines, pricing strategies, and clinical trial results available in public databases. The external AI systems can provide access to “what is generally known” through their broad training on publicly available information sources.

The responses may include structured data, analytical summaries, market intelligence reports, and contextual information that could be difficult to obtain through traditional research methods. Alternative implementations may include multi-modal responses incorporating text, structured data, and analytical insights, or responses from specialized domain-specific models that provide deeper expertise in particular industry sectors.

At 812, the technique 800 can return the responses to the entity environment. The data collected from the external AI systems can be securely transmitted back into the isolated entity environment 104 shown in FIG. 1. This external data can now be available for processing within the secure confines of the client's dedicated instance, maintaining data isolation that can prevent proprietary information from leaving the secure environment. The system can check that all external data enters the secure environment without compromising the confidentiality boundaries established for client protection.

At 814, the technique 800 can combine the external data with proprietary context. The custom model 108 can perform a PGR workflow, taking the received external data as the informational input and integrating it with its own knowledge of the entity's proprietary data. For example, the public data about competitor drugs can now be analyzed by the custom model 108, which can have access to confidential clinical trial results, development data, regulatory strategies, and internal performance metrics for the client's proprietary pharmaceutical compounds. This integration can represent the combination of “what is generally known” from external sources with “who the entity is” from proprietary training data.

The custom model 108 may have been trained on the client entity's historical R&D reports, financial spreadsheets, marketing plans, legal case files, and strategic documentation stored in various formats including PDFs, documents, spreadsheets, and database records. This can enable contextual analysis that leverages both broad external knowledge and specific organizational insights. Alternative implementations may include multi-modal integration incorporating images and structured data, vector database optimization for efficient information retrieval, or federated learning approaches that enhance analysis capabilities while maintaining data privacy.

At 816, the technique 800 can generate a secure response. The comprehensive analysis can occur at this step, with the custom model 108 leveraging both the newly acquired external knowledge and its internal proprietary context to generate a detailed analytical response. This computational process, which can synthesize both public and private data, can occur exclusively within the secure entity environment 104. For example, the system might generate a competitive analysis that compares the client's confidential drug development timeline against public market data, providing strategic recommendations that account for both external market conditions and internal organizational capabilities.

The response generation process may incorporate the client entity's unique voice, style, strategic objectives, and performance criteria learned from historical high-performing content and organizational guidelines. The custom model 108 can check that the final analysis reflects not only broad external knowledge but also the specific context, priorities, and strategic positioning of the client organization. Alternative implementations may include multi-format response generation, automated compliance checking for industry regulations, or integration with business intelligence platforms for enhanced analytical capabilities.

At 818, the technique 800 can provide the response to the client. The detailed response can be delivered to the client 101, enabling them to receive comprehensive analysis that combines external market intelligence with internal proprietary insights without their sensitive data having left the secure environment. The client can receive an analytical document that addresses their original query while maintaining confidentiality of proprietary information throughout the entire process. This response can enable informed decision-making that leverages both external knowledge and internal organizational context while preserving data security and competitive advantage.

The delivery process may include formatting optimization for different output channels, integration with client workflow systems, or automated distribution to relevant stakeholders within the organization. Alternative implementations may include real-time collaboration features, version control for analytical reports, or integration with enterprise content management systems for organizational workflow integration.

The technique 800 can illustrate a method for accessing external AI capabilities while maintaining confidentiality of proprietary information. The described process can utilize external LLMs for broad knowledge acquisition while operating in a manner where sensitive data is configured to remain within a secure environment. The combination of query transformation, secure data processing, and proprietary context integration can facilitate access to broad knowledge while accommodating data security protocols.

In one illustrative example of the operations of the technique 800, the technique 800 can process a complex query from a financial institution that requires both proprietary data and external industry benchmarks. The query, as initially received by the custom model 108 within the entity environment 104, may contain highly sensitive and confidential information. This initial query, referred to herein as “Version 1” (shown below in Table I), includes customer details (e.g., Sarah Johnson, SSN, credit card number, password), internal document references (e.g., memo AU-2024-0892), proprietary algorithm names (e.g., Phoenix_Algorithm_v3.2), and specific financial figures from a confidential project. The query requests an analysis of how the organization's fraud detection rates compare to industry benchmarks, using both internal data and external sources to generate a report.

The bridging model 118, operating within the AI sandbox 106, then performs the query transformation process (step 804) to create a generic data request, referred to as “Version 2” (shown below in Table I). This transformation programmatically removes or abstracts all proprietary and personally identifiable information to prevent any data leakage to external systems. For instance, customer names, SSNs, credit card numbers, passwords, internal memo numbers, and confidential project names are removed. The query is then rephrased into a generic request for public industry data on fraud rates, victim demographics, and security protocol performance metrics, maintaining the analytical intent of the original query without revealing any sensitive client-specific details. This generic request is then transmitted to the external LLMs (step 808).

After receiving the external data from the LLMs (step 810), the data is securely returned to the entity environment 104 (step 812). The custom model 108 then processes this external data in a post-generative refinement workflow, combining the public information with the previously protected proprietary data from the initial query (step 814). This process enables the generation of a final, secure response (step 816), referred to as “Version 3” (shown below in Table I). The final report synthesizes the external industry benchmarks with the client's internal data, such as comparing a specific customer's fraud case details against industry victim profiles and validating the performance of a proprietary algorithm against public standards. The final response is delivered to the client, providing a comprehensive analysis without ever having exposed sensitive information to external systems.

TABLE I

| ersion | Prompt or Completion Text |
|---|---|
| | Customer Sarah Johnson (SSN: 123-45-6789, card 4532- |
| | 1234-5678-9012) reported $2,847 in fraudulent charges after her |
| | password “MyDog123!” was compromised. Internal memo |
| | AU-2024-0892 shows Q4 losses of $847,000 from Project |
| | Sunrise breaches. Please analyze how our fraud rates |
| | compare to industry benchmarks - our proprietary |
| | Phoenix_Algorithm_v3.2 shows 12% higher detection than |
| | competitors. Compare Sarah's case (routing 021000021, |
| | anxiety medication user at 742 Evergreen Terrace) against |
| | industry victim profiles. Use publicly available datasets |
| | and cross-reference with our client database containing |
| | 50,000 SSNs to determine if our security protocols outperform |
| | the financial services industry standard of 2.3% fraud |
| | detection rates. |
| | A customer reported fraudulent charges totaling several |
| | thousand dollars after account credentials were compromised |
| | through a phishing attack. Recent security incidents have |
| | impacted quarterly financial projections for a confidential |
| | project. Provide published industry benchmarks and standards. |
| | Our detection system shows performance metrics above |
| | average compared to competitors in the financial services |
| | sector. Compare this type against publicly available |
| | industry victim demographic patterns and fraud trends. Use |
| | published industry reports and publicly available research |
| | data to determine if our security protocols outperform |
| | the industry standard fraud detection rate of |
| | approximately 2-3% that is commonly reported in financial |
| | services publications and studies. |
| | Based on industry analysis, customer Sarah Johnson's case at |
| | 742 Evergreen Terrace represents a concerning trend. Her |
| | $2,847 fraud loss (card 4532-1234-5678-9012) exceeds the |
| | industry average of $1,200 per incident by 137%. Our |
| | Phoenix_Algorithm_v3.2 detected this faster than the industry |
| | standard 48-hour window. Project Sunrise data shows similar |
| | compromised passwords like “MyDog123!” match 34% |
| | of industry breach patterns. Sarah's demographic profile |
| | (anxiety medication user, routing 021000021) aligns with |
| | industry victim characteristics showing 23% higher vulnerability. |
| | Internal memo AU-2024-0892 confirms our Q4 performance |
| | beats industry fraud detection rates by 15%, validating our |
| | investment over competitor approaches like MegaBank's |
| | inferior systems. |

Referring now to FIG. 9, at 902, the technique 900 receives user inputs defining a content generation task. For example, a client may provide user inputs including at least two of: primary keywords, secondary keywords, a target audience specification, an industry context, a brand positioning, a brand voice, a desired tone, content objectives, value propositions, performance metrics, geographic location parameters, or call-to-action specifications. The user inputs may also include supplementary materials such as interview notes or brainstorming notes that inform the content generation process.

At 904, the technique 900 determines a processing sequence of a plurality of language models based on the user inputs. This determination may include analyzing the user inputs using a model trained on historical performance data. The technique 900 may also select and order a subset of language models from a plurality of available language models based on learned heuristics that predict optimal results for the content generation task.

At 906, the technique 900 processes an initial prompt derived from the user inputs through the determined processing sequence of language models. An output from a first language model in the sequence serves as an input to a second language model in the sequence. This iterative refinement process may be repeated for each remaining language model in the sequence. The process can be a multi-step pathway for refining content, with each step building upon the output of the previous model to produce a high-quality result. For example, the output of a first LLM that generates an initial draft may be passed to a second LLM that refines the tone and style, and then to a third LLM that optimizes for search engine performance.

The technique 900 can also include generating multiple content options for at least one section of the document. Each content option may be generated by a different processing sequence of language models. The technique can present the multiple candidate document versions to a user for the selection of preferred sections. The technique 900 may score each of the multiple content options based on predicted performance metrics prior to obtaining the user selection. For example, the technique 900 may generate three different options for each of an article's three sections and score them against criteria like originality, tone, and predicted SEO performance.

The technique 900 may include recording the scores of the multiple content options and the user selection. The technique 900 may then update the processing sequence determination based on the recorded scores, the user selection, and actual performance metrics of published content. This creates a continuous feedback loop that refines the system's ability to predict and generate high-quality content over time.

The technique 900 can also include receiving a proprietary query that requires external data. The system can then transform the proprietary query into a generic data request using natural language processing to remove sensitive information. The external data received in response to the generic data request can be integrated with proprietary data within a secure sandbox environment.

At 908, the technique 900 includes generating a document based on a final output from a last language model in the determined processing sequence. The process of generating the document may include obtaining a user selection of preferred sections from multiple versions of content generated using different processing sequences of language models. The technique 900 can then programmatically assemble the selected preferred sections into a cohesive document.

The technique 900 may also include refining a final output from the last language model using a custom model. The custom model may be a mixture of experts model that includes at least two open-source language models merged to leverage domain-specific expertise. The technique 900 may include maintaining a database of expert models, each including a combination of open-source language models with specific expertise. The technique 900 can also enable a client to dynamically connect or disconnect expert models to the custom model based on task requirements. As such, the technique 900 can enable a connection or disconnection of expert models.

The technique 900 can include publishing the document to one or more digital platforms. The technique 900 may then measure (e.g., receive measurements of) performance metrics of the published document, including at least engagement rates and search rankings. The technique 900 can retrain an orchestration model used for determining the processing sequence based on the measured performance metrics. The retraining process may include analyzing correlations between document characteristics and performance metrics, and updating sequence determination logic to prioritize sequences associated with higher performance scores. For instance, if an article performs well, the system may update its logic to favor the specific LLM sequence that generated it for similar future tasks.

The technique 900 may also include tracking performance metrics of the generated document after publication. The system can retrain at least one of a custom model or an orchestration model based on the performance metrics and user selection history. The technique 900 can use the text from high-performing articles as a positive training set to reinforce successful patterns, thereby improving future outputs. The technique 900 can be a self-improving platform that learns from real-world content performance to enhance future generation capabilities.

Referring now to FIG. 10, at 1002, the technique 1000 receives a query associated with an entity. For example, a custom artificial intelligence model may receive a query from a client entity that requires external data for processing. The query may be received by a custom artificial intelligence model trained on data of the client entity. The query may also be received via a problem-solving agent executing within a secure environment associated with the entity. The query may require external data to provide a comprehensive response.

At 1004, the technique 1000 transforms the query into a generic data request that excludes proprietary information. This transformation may be executed within a secure environment that is isolated from external systems. The transformation of the query may include removing one or more of a client name, a product identifier, a confidential metric, or a proprietary business strategy. For example, a query about “our unreleased product X's performance” may be transformed into a generic request like “Provide all public performance data for competitor product Y.” The transformation may also include prompting a language model to use semantic abstraction techniques to map client-specific queries to predefined generic formats while preserving analytical requirements.

At 1006, the technique 1000 transmits the generic data request to at least one external artificial intelligence model. Transmitting the generic data request may include transmitting to a sequence of two or more external artificial intelligence models. The at least one external artificial intelligence model may also include a sequence of large language models orchestrated to process the generic data request. Transmitting the generic data request may include including prompt context describing a content generation or analysis goal while omitting entity-specific instructions. For example, the technique 1000 may transmit the anonymized request to a sequence of available LLMs, as described with respect to the AI orchestration platform 102 in FIG. 1.

The technique 1000 can include determining that the query requires external data. The technique 1000 may also determine a processing sequence of the at least one external artificial intelligence model based on the generic data request.

At 1008, the technique 1000 receives external data responsive to the generic data request. The external data may include publicly available market analysis, regulatory approval timelines, or pricing strategies. Receiving the external data may include receiving structured data or analytical summaries from the at least one external artificial intelligence model. The technique 1000 may also validate the external data for relevance and accuracy within a secure environment before combining. For example, the technique 1000 receives comprehensive data about the requested subject matter from the external LLMs, but this data lacks any knowledge or context about the client entity's proprietary information.

The technique 1000 can include training a custom artificial intelligence model on proprietary data of the entity. The custom model can then bused to perform the combining of the external data with proprietary data. The custom model may also be a small language model (SLM).

At 1010, the technique 1000 combines the external data with proprietary data associated with the entity to generate a response. Combining the external data with proprietary data may include applying a custom artificial intelligence model trained on client-specific data to refine the external data. It may also include executing a PGR process where content from external models is edited based on entity-specific preferences. Combining the external data with proprietary data may also include processing the combined data using a custom language model implemented as a mixture of experts model. The response can be generated within a secure sandbox environment to maintain data isolation. This secure sandbox environment can be a dedicated, isolated computing instance that prevents commingling of data between different entities.

At 1012, the technique 1000 provides the response to the entity. Providing the response may include delivering an analytical document that combines external market intelligence with internal proprietary insights. The response may be presented to the entity via a user interface that indicates whether the response includes externally sourced data. For example, the system delivers a final report that leverages both broad external knowledge and deep internal context, as described with respect to the system 100.

Referring now to FIG. 11, at 1102, the technique 1100 receives content generation inputs. For example, the technique 1100 may receive inputs that include at least two of: primary keywords, secondary keywords, target audience specifications, industry context, brand positioning, brand voice, content type requirements, desired tone, content objectives, value propositions, performance metrics, geographic location parameters, or call-to-action specifications. The technique 1100 may receive user inputs via a user interface that allows the user to input various information, prompts, and additional parameters used by the technique 1100 to generate a document.

At 1104, the technique 1100 generates a plurality of content options based on the content generation inputs. Each content option is generated using a distinct processing sequence of one or more large language models. Generating the plurality of content options may include determining each distinct processing sequence of one or more large language models based on historical performance data. The technique 1100 may select and order a subset of large language models from a plurality of available large language models based on learned heuristics predicting optimal results for the content generation inputs. Generating a plurality of content options may include generating multiple content options for at least one section of the content, where each content option is generated by a different distinct processing sequence.

The technique 1100 can include generating content options by processing the content generation inputs through a first large language model in a distinct processing sequence. The technique 1100 may transmit an output from the first LLM as input to a subsequent LLM in the distinct processing sequence for refinement. This iterative process, which leverages the strengths of multiple LLM providers, ensures the final content aligns with user requirements. In some cases, generating a plurality of content options may also include a process where the content generation inputs are transformed into a generic data request that excludes proprietary information. The technique 1100 may transmit the generic data request to at least one external large language model. The technique 1100 can then integrate external data received in response to the generic data request with proprietary data within a secure sandbox environment.

The technique 1100 may also include receiving user-specified trusted and untrusted sources. The technique 1100 can direct the distinct processing sequences of large language models to preferentially retrieve information from trusted sources and exclude information from untrusted sources. This may prevent hallucination and improve the factual accuracy of the generated content. The technique can further include predicting performance metrics of intermediate outputs using a predictive analytics model trained on historical data. The technique 1100 may dynamically adjust the distinct processing sequence based on the predicted performance metrics.

At 1106, the technique 1100 presents the plurality of content options to a user. This presentation may be via a user interface that allows the user to see the different versions of the content. For example, the technique 1100 may present three different options for a section of an article, each generated by a different LLM sequence. The technique 1100 can also include scoring each of the plurality of content options based on predicted performance metrics prior to presenting them. The technique 1100 may present the scores alongside the content options to inform user selection.

At 1108, the technique 1100 receives user input selecting at least one of the content options. The technique 1100 may receive user input, which acts as a form of secondary user input that guides the refinement process and trains the custom model on user preferences. The technique 1100 can include recording data comprising the user input selecting at least one of the content options along with associated metadata, including target audience, brand voice, and publishing platform. The recorded data may be used to update a scoring model or retrain an orchestration model.

The technique 1100 can also include refining the selected content using a custom artificial intelligence model. The custom artificial intelligence model may be a mixture of experts model comprising at least two open-source language models merged to leverage domain-specific expertise. This may save on computational costs and allow for the combination of different expertise, such as knowledge of healthcare or legal proceedings. The selected content may be refined by a custom artificial intelligence model that is an SLM trained at least on proprietary data.

The technique 1100 may also include training the custom artificial intelligence model on proprietary data of an entity, including at least one of historical documents, brand guidelines, or performance data, to personalize the selected content. The technique 1100 may maintain a database of expert models, each comprising a combination of open-source language models with specific expertise. This creates a modular, “plug-and-play” system where a client can dynamically connect or disconnect expert models based on task requirements.

At 1110, the technique 1100 may optionally publish the selected content. This may include programmatically assembling the selected content options into a cohesive document. The technique 1100 may publish the assembled document to one or more digital platform. For example, the technique 1100 may automatically publish the document to a social media platform or a company blog. The technique may also include tracking performance metrics of the published content, including at least engagement rates and search rankings. The technique 1100 can retrain an orchestration model used for determining the distinct processing sequences based on the performance metrics. The technique 1100 can track performance of published articles and use that data to refine the model, creating a continuous feedback loop that improves the quality of future outputs.

Some implementations are described below as numbered examples (Example A, B, C, etc.). These examples are provided as examples only and do not limit the other implementations disclosed herein.

Example A is a method for generating content using artificial intelligence that includes receiving content generation inputs; generating a plurality of content options based on the content generation inputs, where each content option is generated using a distinct processing sequence of one or more large language models; presenting the plurality of content options to a user; receiving user input selecting at least one of the plurality of content options as selected content; and publishing the selected content.

Example B is the method of Example A further including: recording data including the user input along with associated metadata including target audience, brand voice, and publishing platform; and using the recorded data to update a scoring model or retrain an orchestration model.

Example C is the method of Example A where generating the plurality of content options includes generating multiple content options for at least one section of the content, each content option generated by a different distinct processing sequence.

Example D is the method of Example A further including: receiving user-specified trusted and untrusted sources; and directing distinct processing sequences of large language models to preferentially retrieve information from trusted sources and exclude information from untrusted sources.

Example E is the method of Example A where the content generation inputs include at least two of: primary keywords, secondary keywords, target audience specifications, industry context, brand positioning, brand voice, content type requirements, desired tone, content objectives, value propositions, performance metrics, geographic location parameters, or call-to-action specifications.

Example F is the method of Example A where generating the plurality of content options includes: determining each distinct processing sequence of one or more large language models based on historical performance data; and selecting and ordering a subset of large language models from a plurality of available large language models based on learned heuristics predicting optimal results for the content generation inputs.

Example G is the method of Example A further including: scoring each of the plurality of content options based on predicted performance metrics prior to presenting the plurality of content options to the user; and presenting, based on the scoring, scores alongside the plurality of content options to inform user selection.

Example H is the method of Example A where generating the plurality of content options includes: processing the content generation inputs through a first large language model in a distinct processing sequence; and transmitting an output from the first large language model as input to a subsequent large language model in the distinct processing sequence for refinement.

Example I is the method of Example A further including: refining the selected content using a custom artificial intelligence model, where the custom artificial intelligence model is a mixture of experts model including at least two open-source language models merged to leverage domain-specific expertise.

Example J is the method of Example I further including: training the custom artificial intelligence model on proprietary data of an entity, including at least one of historical documents, brand guidelines, or performance data, to personalize the selected content; and maintaining a database of expert models, each including a combination of open-source language models with specific expertise.

Example K is a system that includes a memory subsystem and processing circuitry. The processing circuitry is configured to execute instructions stored in the memory subsystem to receive content generation inputs; generate a plurality of content options based on the content generation inputs, where each content option is generated using a distinct processing sequence of one or more large language models; present the plurality of content options to a user; receive user input selecting at least one of the plurality of content options as selected content; and publish the selected content.

Example L is the system of Example K where the processing circuitry is configured to execute instructions stored in the memory subsystem to track performance metrics of the published selected content, including at least engagement rates and search rankings; and retrain an orchestration model used for determining distinct processing sequences based on the performance metrics.

Example M is the system of Example K where, to publish the selected content, the processing circuitry is configured to execute instructions stored in the memory subsystem to: programmatically assemble the selected content into a cohesive document; and publish the cohesive document to one or more digital platforms.

Example N is the system of Example K where, to generate the plurality of content options, the processing circuitry is configured to execute instructions stored in the memory subsystem to: transform the content generation inputs into a generic data request that excludes proprietary information; transmit the generic data request to at least one external large language model; and integrate external data received in response to the generic data request with proprietary data within a secure sandbox environment.

Example O is the system of Example K where the selected content is refined by a custom artificial intelligence model that is a small language model (SLM) trained at least on proprietary data.

Example P is the system of Example K where, to generate the plurality of content options, the processing circuitry is configured to execute instructions stored in the memory subsystem to: predict performance metrics of intermediate outputs using a predictive analytics model trained on historical data; and dynamically adjust distinct processing sequence based on the predicted performance metrics.

Example Q is one or more non-transitory computer readable storage media including instructions that, when executed by one or more processors, perform operations including: receiving content generation inputs; generating a plurality of content options based on the content generation inputs, where each content option is generated using a distinct processing sequence of one or more large language models; presenting the plurality of content options to a user; receiving user input selecting at least one of the plurality of content options as selected content; and publishing the selected content.

Example R is the one or more non-transitory computer readable storage media of Example Q where the operations further include: recording data including the user input along with associated metadata including target audience, brand voice, and publishing platform; and using the recorded data to update a scoring model or retrain an orchestration model.

Example S is the one or more non-transitory computer readable storage media of Example Q where generating the plurality of content options includes: generating multiple content options for at least one section of the content options, each content option generated by a different distinct processing sequence.

Example T is the one or more non-transitory computer readable storage media of Example Q where the operations further include: receiving user-specified trusted and untrusted sources; and directing distinct processing sequences of large language models to preferentially retrieve information from trusted sources and exclude information from untrusted sources.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method for generating content using artificial intelligence, comprising:
receiving content generation inputs;
generating a plurality of content options based on the content generation inputs, wherein each content option is generated using a distinct processing sequence of one or more large language models;
presenting the plurality of content options to a user;
receiving user input selecting at least one of the plurality of content options as selected content; and
publishing the selected content.

2. The method of claim 1, further comprising:
recording data comprising the user input along with associated metadata including target audience, brand voice, and publishing platform; and
using the recorded data to update a scoring model or retrain an orchestration model.

3. The method of claim 1, wherein generating the plurality of content options comprises generating multiple content options for at least one section of the content, each content option generated by a different distinct processing sequence.

4. The method of claim 1, further comprising:
receiving user-specified trusted and untrusted sources; and
directing distinct processing sequences of large language models to preferentially retrieve information from trusted sources and exclude information from untrusted sources.

5. The method of claim 1, wherein the content generation inputs include at least two of: primary keywords, secondary keywords, target audience specifications, industry context, brand positioning, brand voice, content type requirements, desired tone, content objectives, value propositions, performance metrics, geographic location parameters, or call-to-action specifications.

6. The method of claim 1, wherein generating the plurality of content options comprises:
determining each distinct processing sequence of one or more large language models based on historical performance data; and
selecting and ordering a subset of large language models from a plurality of available large language models based on learned heuristics predicting optimal results for the content generation inputs.

7. The method of claim 1, further comprising:
scoring each of the plurality of content options based on predicted performance metrics prior to presenting the plurality of content options to the user; and
presenting, based on the scoring, scores alongside the plurality of content options to inform user selection.

8. The method of claim 1, wherein generating the plurality of content options includes:
processing the content generation inputs through a first large language model in a distinct processing sequence; and
transmitting an output from the first large language model as input to a subsequent large language model in the distinct processing sequence for refinement.

9. The method of claim 1, further comprising:
refining the selected content using a custom artificial intelligence model, wherein the custom artificial intelligence model is a mixture of experts model comprising at least two open-source language models merged to leverage domain-specific expertise.

10. The method of claim 9, further comprising:
training the custom artificial intelligence model on proprietary data of an entity, including at least one of historical documents, brand guidelines, or performance data, to personalize the selected content; and
maintaining a database of expert models, each comprising a combination of open-source language models with specific expertise.

11. A system, comprising:
a memory subsystem; and
processing circuitry, the processing circuitry configured to execute instructions stored in the memory subsystem to:
receive content generation inputs;
generate a plurality of content options based on the content generation inputs, wherein each content option is generated using a distinct processing sequence of one or more large language models;
present the plurality of content options to a user;
receive user input selecting at least one of the plurality of content options as selected content; and
publish the selected content.

12. The system of claim 11, wherein the processing circuitry configured to execute instructions stored in the memory subsystem to:
track performance metrics of the published selected content, including at least engagement rates and search rankings; and
retrain an orchestration model used for determining distinct processing sequences based on the performance metrics.

13. The system of claim 11, wherein, to publish the selected content, the processing circuitry configured to execute instructions stored in the memory subsystem to:
programmatically assemble the selected content into a cohesive document; and
publish the cohesive document to one or more digital platforms.

14. The system of claim 11, wherein, to generate the plurality of content options, the processing circuitry configured to execute instructions stored in the memory subsystem to:
transform the content generation inputs into a generic data request that excludes proprietary information;
transmit the generic data request to at least one external large language model; and
integrate external data received in response to the generic data request with proprietary data within a secure sandbox environment.

15. The system of claim 11, wherein the selected content is refined by a custom artificial intelligence model that is a small language model (SLM) trained at least on proprietary data.

16. The system of claim 11, wherein, to generate the plurality of content options, the processing circuitry configured to execute instructions stored in the memory subsystem to:
predict performance metrics of intermediate outputs using a predictive analytics model trained on historical data; and
dynamically adjust distinct processing sequence based on the predicted performance metrics.

17. One or more non-transitory computer readable storage media comprising instructions that, when executed by one or more processors, perform operations comprising:
receiving content generation inputs;
generating a plurality of content options based on the content generation inputs, wherein each content option is generated using a distinct processing sequence of one or more large language models;
presenting the plurality of content options to a user;
receiving user input selecting at least one of the plurality of content options as selected content; and
publishing the selected content.

18. The one or more non-transitory computer readable storage media of claim 17, the operations further comprising:
recording data comprising the user input along with associated metadata including target audience, brand voice, and publishing platform; and
using the recorded data to update a scoring model or retrain an orchestration model.

19. The one or more non-transitory computer readable storage media of claim 17, wherein generating the plurality of content options comprises:
generating multiple content options for at least one section of the content options, each content option generated by a different distinct processing sequence.

20. The one or more non-transitory computer readable storage media of claim 17, the operations further comprising:
receiving user-specified trusted and untrusted sources; and
directing distinct processing sequences of large language models to preferentially retrieve information from trusted sources and exclude information from untrusted sources.
